(19) United States
(12) Patent Application Publication
(10) Pub. No.: US 2024/0062349 A1
(43) Pub. Date: Feb. 22, 2024

(54) ENHANCED HIGH DYNAMIC RANGE PIPELINE FOR THREE-DIMENSIONAL IMAGE SIGNAL PROCESSING

(71) Applicant: GM Cruise Holdings LLC, San Francisco, CA (US)

(72) Inventors: Zhanping Xu, Sunnyvale, CA (US); Brandon S. Seilhan, San Ramon, CA (US); Glenn D. Sweeney, Sebastopol, CA (US); Juan Sebastian Hurtado Jaramillo, San Francisco, CA (US); Kartheek Chandu, Dublin, CA (US)

(21) Appl. No.: 17/891,355

(22) Filed: Aug. 19, 2022

(51) Int. Cl. G06T 5/00; G06T 5/50; G06T 3/40

(52) U.S. Cl. CPC G06T 5/007; G06T 5/50; G06T 3/40; G06T 2207/20208; G06T 2207/20016

(57) ABSTRACT

Systems and techniques are provided for high dynamic range (HDR) with time-of-flight (TOF) cameras. An example method can include obtaining, from a TOF camera, correlation samples including a first set of correlation samples with a first integration time and a second set of correlation samples with a second integration time; determining that a first correlation sample from the first set of correlation samples is saturated; based on the determining that the first correlation sample is saturated, inferring that a second correlation sample from the first set of correlation samples is also saturated; replacing the first correlation sample and the second correlation sample with one or more scaled versions of one or more correlation samples from the second set of correlation samples; and generating an HDR TOF frame based on the one or more scaled versions of the one or more correlation samples and the second set of correlation samples.

### TECHNICAL FIELD

The present disclosure generally relates to depth estimation using time-of-flight cameras. For example, aspects of the present disclosure relate to techniques and systems for an enhanced high dynamic range pipeline for three-dimensional image signal processing.

### BACKGROUND

Image sensors are commonly integrated into a wide array of systems and electronic devices such as, for example, camera systems, mobile phones, autonomous systems (e.g., unmanned aerial vehicles or drones, autonomous vehicles, robots, etc.), computers, smart wearables, and many other devices. The image sensors allow users to capture frames (e.g., video frames and/or still pictures/images) from any electronic device equipped with an image sensor. The frames can be captured for recreational use, automation, professional photography, surveillance, modeling, and depth estimation, among other applications. The quality of a frame can depend on the capabilities of the image sensor used to capture the frame and a variety of factors such as, for example, exposure, resolution, framerate, dynamic range, etc. Exposure relates to the amount of light that reaches the image sensor, as determined by a shutter speed or exposure time (also referred to as integration time), lens aperture, and scene luminance.

High dynamic range (HDR) technologies are often used when capturing frames of a scene with bright and/or dark areas to produce higher quality frames. The HDR technologies can combine frames with different exposures to reproduce a greater range of color and luminance levels than otherwise possible with standard imaging techniques. The HDR technologies can help retain or produce a greater range of highlight, color, and/or shadow details on a captured frame. Consequently, HDR technologies can yield higher quality frames in scenes with a wide array of lighting conditions. Moreover, HDR technologies can be implemented in a variety of contexts, such as autonomous driving, to produce higher quality frames for specific uses such as, for example, autonomous driving operations performed by an autonomous vehicle (AV).

### BRIEF DESCRIPTION OF THE DRAWINGS

Illustrative examples and aspects of the present application are described in detail below with reference to the following figures:

FIG. 1 is a diagram illustrating an example system environment that can be used to facilitate autonomous vehicle (AV) navigation and routing operations, in accordance with some examples of the present disclosure;

FIG. 2 is a diagram illustrating an example of an electronic device used to capture sensor data, in accordance with some examples of the present disclosure;

FIG. 3 is a diagram illustrating an example operation of a time-of-flight camera, in accordance with some examples of the present disclosure;

FIG. 4 is a diagram illustrating an example sequence of time-of-flight samples, in accordance with some examples of the present disclosure;

FIG. 5 is a chart illustrating pairs of correlation samples and their respective relationships,

FIG. 6 is a diagram illustrating an example saturation scenario including saturated correlation samples and unsaturated correlation samples, in accordance with some examples of the present disclosure;

FIG. 7 is a diagram illustrating another example saturation scenario, in accordance with some examples of the present disclosure;

FIG. 8 is a diagram illustrating another example saturation scenario, in accordance with some examples of the present disclosure;

FIG. 9 is a diagram illustrating another example saturation scenario, in accordance with some examples of the present disclosure;

FIG. 10 is a chart illustrating an example enhanced time-of-flight high dynamic range pipeline, in accordance with some examples of the present disclosure;

FIG. 11 illustrates an example confidence map corresponding to a depth map generated in accordance with some examples of the present disclosure;

FIG. 12A is a flowchart illustrating an example process for generating a time-of-flight high dynamic range frame, in accordance with some examples of the present disclosure;

FIG. 12B is a flowchart illustrating an example process for generating a time-of-flight high dynamic range frame and a confidence map, in accordance with some examples of the present disclosure;

FIG. 13 is a flowchart illustrating an example process for implementing high dynamic range with time-of-flight cameras, in accordance with some examples of the present disclosure;

FIG. 14 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of the subject matter of the application. However, it will be apparent that various aspects and examples of the disclosure may be practiced without these specific details. The figures and description are not intended to be restrictive.

The ensuing description provides examples and aspects of the disclosure, and is not intended to limit the scope, applicability, or configuration of the disclosure. Rather, the ensuing description of the examples and aspects of the disclosure will provide those skilled in the art with an enabling description for implementing an example implementation of the disclosure. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, high dynamic range (HDR) technologies can be used to improve a quality of frames (e.g., video frames or still images/pictures) captured by a camera device of a scene with bright and/or dark areas. The HDR technologies can combine frames with different exposures (also referred to herein as integration times) to reproduce a greater range of color and luminance levels than otherwise possible with standard imaging techniques. HDR technologies can help retain or produce a greater range of highlight, color, and/or shadow details on a captured frame. Consequently, HDR technologies can yield higher quality frames in scenes with a wide array of lighting conditions.

HDR technologies can be implemented in a variety of contexts to produce higher quality frames. For example, in some cases, HDR technologies can be implemented by an autonomous vehicle (AV) for various operations performed by the AV, such as autonomous driving operations. An AV is a motorized vehicle that can navigate without a human driver. An example AV can include various sensors, such as an image sensor, a light detection and ranging (LIDAR) sensor, a radio detection and ranging (RADAR) sensor, an inertial measurement unit (IMU), and/or a time-of-flight camera sensor, amongst others. The sensors collect data and measurements that the AV can use for operations such as navigation. The sensors can provide the data and measurements to an internal computing system of the AV, which can use the data and measurements to control a mechanical system of the AV such as a vehicle propulsion system, a braking system, or a steering system. Typically, the sensors are mounted at specific locations on the AVs.

In some examples, HDR processing can be implemented by three-dimensional (3D) time-of-flight (TOF) cameras to increase and/or optimize the dynamic range of frames captured by the 3D TOF cameras. The frames captured by the 3D TOF cameras can be used to estimate depth information of targets (e.g., objects, animals, humans, traffic signs, scene elements, devices, vehicles, etc.) in a scene. For example, an internal computing system of an AV can use a 3D TOF camera to measure a distance of each pixel in a frame captured by the 3D TOF camera relative to the 3D TOF camera. The distance information can be used to obtain a representation of the spatial structure, distance, and/or geometry of a scene and/or a target in the scene.

A TOF camera can include a range imaging camera system that resolves distance based on the known speed of light, a measured time-of-flight of a light signal between the camera and target in the scene for each point of a captured frame. In some examples, the image sensor of a TOF camera can capture a two-dimensional (2D) frame or several 2D frames, from which a processor can determine the distance to targets in the scene. The TOF camera can be equipped with a light source that illuminates targets in a scene whose distances from the TOF camera are to be measured by detecting the time it takes the emitted light to return to the image sensor of the TOF camera. In some cases, the system may also utilize one or more image processing techniques, such as HDR processing techniques as further described herein.

TOF depth image processing methods can include collecting correlation samples (CSs) to calculate a phase estimate. In some examples, the correlation samples of a TOF pixel can be collected at one or more time points, such as sequential time points, and at different phase offset/shift conditions. The signal strength of the correlation samples varies with the different phase shifts. Therefore, these samples output from the TOF pixel have different values. In some cases, each pixel of a 3D TOF camera can output a distance between the camera and a target in a scene. One example technique to measure depth is to calculate the time it takes for the light to travel from a light source on the camera to a reflective surface and back to the camera. This travel time is commonly referred as time of flight.

In some cases, the conditions in a scene can cause a correlation sample captured by a TOF camera to be fully saturated (e.g., all the correlation samples of the TOF pixel are saturated) or partially saturated (e.g., a subset of the correlation samples of the TOF pixel are saturated). For example, correlation samples captured by the pixel of the TOF camera can be partially or fully saturated in cases where the scene depicted or represented by the correlation sample or a target in the scene includes bright and/or dark areas. Saturation of correlation samples can not only result in lower quality correlation samples but can also negatively impact the quality of depth estimates generated based on the correlation samples. For example, a processor can use correlation samples captured by a TOF camera to generate a depth map representing depth information estimated for a target (e.g., a human, an object, a vehicle, a traffic sign, an animal, a building, a scene element, a device, a structure, etc.) in a scene. The depth map can include depth estimates for pixels in correlation samples corresponding to the target in the scene.

If the correlation samples used to derive the depth map are saturated, the saturated correlation samples can negatively affect the depth estimates generated based on the saturated correlation samples. For example, the saturation of the correlation samples can reduce a quality of the depth estimates generated using the correlation samples. In some cases such as autonomous driving cases, the saturation of the correlation samples can reduce the quality of the depth estimates generated using the correlation samples to unacceptable levels, as it can result in inaccurate or unreliable depth estimates and can negatively impact any AV operations that rely on such depth estimates.

In some aspects, systems, apparatuses, processes (also referred to as methods), and computer-readable media (collectively referred to as “systems and techniques”) are described herein for implementing HDR to increase a quality and/or dynamic range of frames generated based on TOF camera frames. For example, the systems and techniques described herein can generate HDR frames based on fully or partially saturated correlation samples captured by a TOF camera. The HDR frames can increase a quality of the image data and/or the depth estimates generated by the TOF camera even if the correlation sample(s) used to generate such data and/or depth estimates is/are saturated. Thus, the HDR processing implemented by the systems and techniques described herein can improve a quality, dynamic range, and/or signal-to-noise (SNR) ratio of the frames and/or depth maps generated from the correlation samples captured by the TOF camera.

In some examples, the systems and techniques described herein can provide an HDR pipeline with enhanced SNR for 3D image signal processing. The HDR pipeline can produce HDR frames for depth estimation by merging/fusing several correlation samples with different integration times (e.g., also referred to herein as exposure times) captured by one or more TOF cameras. An HDR frame generated using the HDR pipeline described herein can have a greater quality and/or dynamic range than any correlation samples used to generate the HDR frame. Moreover, the HDR frame can be used to obtain depth estimates for pixels corresponding to portions of a target in a scene. The depth estimates generated based on the HDR frame can have a higher quality and/or reliability than depth estimates otherwise generated using the correlation samples without processing the correlation samples through the HDR pipeline described herein or generating the HDR frame as further described herein.

In some cases, the systems and techniques described herein can increase a processor's ability to detect saturation of correlation samples captured by a TOF camera(s) and/or increase a speed at which the processor detects saturation of correlation samples captured by the TOF camera(s). By increasing the speed of detecting saturation of correlation samples, the systems and techniques described herein can reduce a burden on compute resources (e.g., by reducing the amount of operations used to detect saturation and/or the amount of resources used to detect saturation) used to process TOF camera signals and reduce a latency in generating and/or processing TOF camera signals and/or associated depth estimates.

In some examples, the systems and techniques described herein can generate an HDR frame and/or a depth map based on a sequence of correlation samples captured by a TOF camera(s). The systems and techniques described herein can determine a relationship between correlation samples and use the relationship between the correlation samples to increase a speed of detecting saturation of the correlation samples. To illustrate, in some cases, the systems and techniques described herein can implement a phase shifting method with pairs of in phase and out-of-phase correlation samples. The systems and techniques described herein can leverage the in-phase and out-of-phase relationship of correlation samples in a pair to increase a speed of detecting saturation of correlation samples.

For example, if a correlation sample from a pair of correlation samples is saturated, the systems and techniques described herein can infer that the other correlation sample in the pair is also saturated based on the relationship between the pair of correlation samples. Accordingly, the systems and techniques described herein do not need to process both correlation samples in the pair to determine whether both or any of the correlation samples are saturated, as it instead can determine that both correlation samples are saturated by simply detecting a saturation of one of the correlation samples in the pair and inferring a saturation of the other correlation sample in the pair.

In some examples, the sequence of correlation samples can include a first set of correlation samples having a first integration time and a second set of correlation samples having a second integration time. In some cases, the first integration time can include a long integration time (e.g., an integration time above a threshold) and the second integration time can include a short integration time (e.g., an integration time below a threshold). If a correlation sample from the first set of correlation samples with the first integration time is saturated, the systems and techniques described herein can replace the saturated correlation sample with an unsaturated correlation sample from the second set of correlation samples with the second integration time.

In some examples, the systems and techniques described herein can identify a correlation sample from the second set of correlation samples that corresponds to (and/or is associated with) the saturated correlation sample from the first set of correlation samples, and determine whether the identified correlation sample is saturated. If the identified correlation sample is not saturated, the systems and techniques described herein can replace the saturated correlation sample with the identified correlation sample. By replacing the saturated correlation sample with the unsaturated correlation sample, the systems and techniques described herein can improve an overall quality of the sequence of correlation samples and, consequently, the quality of any depth estimates generated using the sequence of correlation samples.

As previously explained, the systems and techniques can implement a phase shifting method with pairs of in phase and out-of-phase correlation samples. Thus, the saturated correlation sample can be a first correlation sample of a pair of in-phase and out-of-phase correlation samples from the first set of correlation samples. Based on the determination that the first correlation sample in the pair of in-phase and out-of-phase correlation samples is saturated, the systems and techniques described herein can infer that a second correlation sample in the pair of in-phase and out-of-phase correlation samples from the first set of correlation samples is also saturated. In other words, if the systems and techniques described herein determine that the first correlation sample in the pair of correlation samples from the first set of correlation samples is saturated, the systems and techniques described herein can infer that both correlation samples (e.g., the first correlation sample and the second correlation sample) in the pair of correlation samples from the first set of correlation samples are saturated.

In addition, the systems and techniques described herein can similarly replace the second correlation sample in the pair from the first set of correlation samples (e.g., the correlation sample inferred to be saturated based on a determination that the first correlation sample in the pair is saturated) with the unsaturated correlation sample from the second set of correlation samples or with a different correlation sample from the second set of correlation samples. In some examples, the different correlation sample from the second set of correlation samples can be part of a pair of in-phase and out-of-phase correlation samples that includes the unsaturated correlation sample from the second set of correlation samples. Thus, the systems and techniques described herein can infer that the different correlation sample is also unsaturated based on a determination that the unsaturated correlation sample from the second set of correlation samples (e.g., the other correlation sample in the pair of in phase and out-of-phase correlation samples from the second set of correlation samples) is unsaturated. In other words, the systems and techniques described herein can infer that both correlation samples in the pair of correlation samples form the second set of correlation samples are unsaturated based on a determination that one of the correlation samples in the pair is unsaturated.

In some cases, in addition to replacing the saturated correlation sample (e.g., the first correlation sample) with the unsaturated correlation sample from the second set of correlation samples, the systems and techniques described herein can replace the other correlation sample (e.g., the second correlation sample inferred to be saturated based on a determination that the first correlation sample in the pair is saturated) from the pair of correlation samples that includes the saturated correlation sample (e.g., the first correlation sample) with the second unsaturated correlation sample (e.g., the other correlation sample in the pair of correlation samples that includes the unsaturated correlation sample form the second set of correlation samples).

For example, the systems and techniques described herein can determine a pair of correlation samples from the first set of correlation samples that includes a correlation sample 1L and a correlation sample 3L, where L stands for long integration time. The systems and techniques described herein can determine that the correlation sample 1L is saturated and can infer that the correlation sample 3L is also saturated based on the relationship between the correlation sample 1L and the correlation sample 3L since the correlation sample 1L and the correlation sample 3L are saturated with the same absolute value but opposite signs. The systems and techniques described herein can determine a pair of correlation samples from the second set of correlation samples that includes correlation sample 1S and correlation sample 3S, where S stands for short integration time. The systems and techniques described herein can determine that correlation sample 1S is unsaturated and infer that correlation sample 3S is also unsaturated based on a relationship between correlation sample 1S and correlation sample 3S since the correlation sample 1S and the correlation sample 3S are unsaturated with the same absolute value but opposite signs. The systems and techniques described herein can then replace correlation sample 1L with unsaturated correlation sample 1S, and correlation sample 3L with unsaturated correlation sample 3S. The new sequence or set of correlation samples can include a set of unsaturated correlation samples such as, for example, correlation sample 1S (e.g., which replaced correlation sample 1L), correlation sample 2L, correlation sample 3S (e.g., which replaced correlation sample 3L), correlation sample 4L, and correlation samples 1S to 4S.

After replacing the saturated correlation samples (e.g., correlation samples 1L and 3L) with unsaturated correlation samples (e.g., with correlation samples 1S and 3S), the systems and techniques described herein can mix/fuse the correlation samples in the resulting sequence of correlation samples to produce an HDR frame with a higher dynamic range and/or a better SNR. Because the saturated correlation samples from the first set of correlation samples have a longer integration time than the unsaturated correlation samples from the second set of correlation samples (e.g., which are used to replace the saturated correlation samples from the first set of correlation samples), the systems and techniques described herein can scale the unsaturated correlation samples before mixing/fusing the correlation samples in the resulting sequence of correlation samples. The systems and techniques described herein can scale the unsaturated correlation samples based on a scaling factor.

In some cases, the scaling factor can be determined based on the integration times of the saturated correlation samples (e.g., the long integration time) and the unsaturated correlation samples (e.g., the short integration time). For example, the scaling factor for the unsaturated correlation sample (e.g., correlation sample 1S) that is used to replace the first saturated correlation sample (e.g., correlation sample 1L) can be calculated by dividing the integration time of the saturated correlation sample (e.g., the long integration time of correlation sample 1L) by the integration time of the unsaturated correlation sample (e.g., the short integration time of the correlation sample 1S). For example, if the integration time of the saturated correlation sample being replaced is X and the integration time of the unsaturated correlation sample used to replace the saturated correlation sample is Y, the scaling factor can be the result of dividing X by Y (e.g., scaling factor=X/Y).

In another illustrative example, the scaling factor can be calculated by dividing the integration time of the saturated correlation sample (e.g., the long integration time of correlation sample 1L) by a result of an addition or subtraction of the integration time of the saturated correlation sample and the integration time of the unsaturated correlation sample. For example, if the integration time of the saturated correlation sample being replaced is X and the integration time of the unsaturated correlation sample used to replace the saturated correlation sample is Y, in some cases the scaling result can be of a nonlinear function f operation, for example, f(1S*X/Y) or f(1S, X, Y) where 1S is not saturated and is used to replace the saturated correlation sample 1L. In yet other examples, the scaling factor can be calculated by applying any other operation using the integration times of the saturated and unsaturated correlation samples.

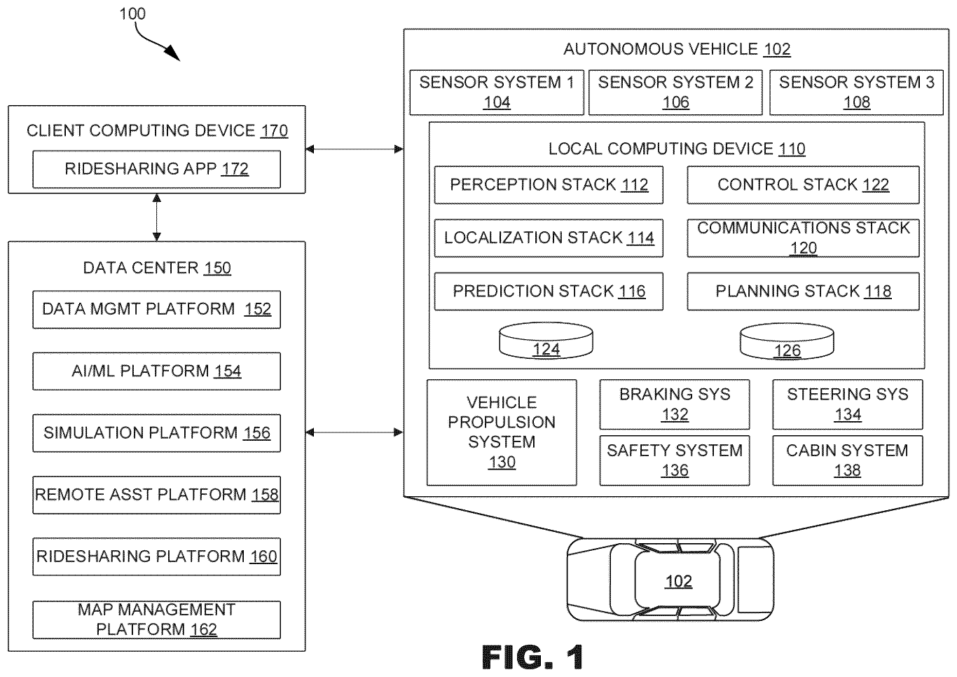

Various examples of the systems and techniques described herein for processing data are illustrated in FIG. 1 through FIG. 14 and described below.

FIG. 1 is a diagram illustrating an example autonomous vehicle (AV) environment 100, according to some examples of the present disclosure. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUS, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AUML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 172. In some cases, the client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit to a pick-up or drop-off location, and so on.

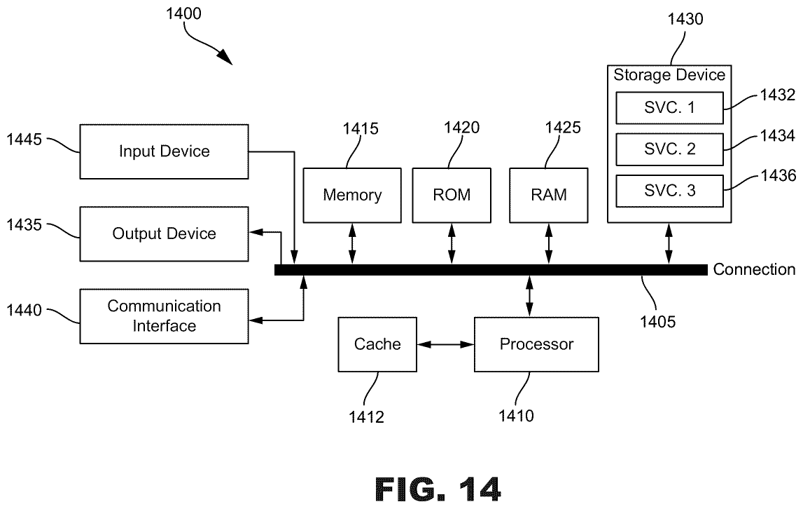

While the AV 102, the local computing device 110, and the autonomous vehicle environment 100 are shown to include certain systems and components, one of ordinary skill will appreciate that the AV 102, the local computing device 110, and/or the autonomous vehicle environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 14.

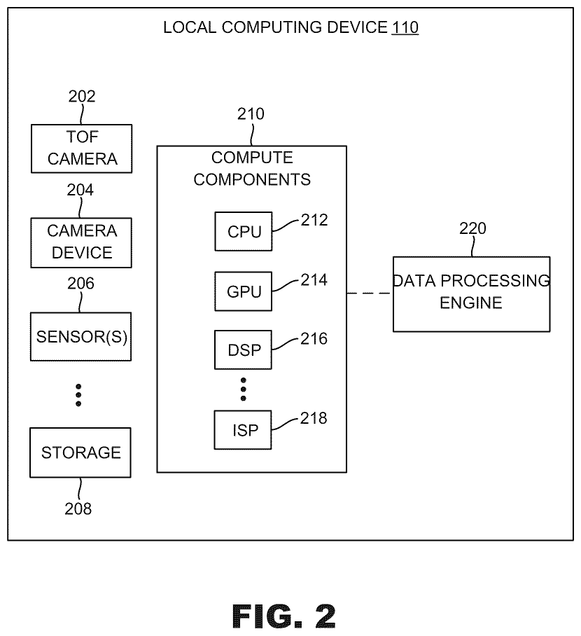

FIG. 2 is a diagram illustrating an example of an electronic device used to capture sensor data. In this example, the electronic device includes or represents the local computing device 110 shown in FIG. 1. However, in other examples, the electronic device can include or represent any other device used to capture and process sensor data as further described herein.

In some examples, the local computing device 110 can include a camera device, such as a time-of-flight (TOF) camera device, and can be configured to perform three-dimensional (3D) image signal processing, including high dynamic range (HDR) processing, as further described herein. In some aspects, the local computing device 110 can be configured to provide one or more functionalities such as, for example, imaging functionalities, 3D image filtering functionalities, image data segmentation functionalities, depth estimation functionalities, phase unwrapping functionalities, HDR processing functionalities, AV perception detection functionalities (e.g., object detection, pose detection, face detection, shape detection, scene detection, etc.), image processing functionalities, extended reality (XR) functionalities (e.g., localization/tracking, detection, classification, mapping, content rendering, etc.), device management and/or control functionalities, autonomous driving functionalities, computer vision, robotic functions, automation, and/or any other computing functionalities.

In the illustrative example shown in FIG. 2, the local computing device 110 can include one or more camera devices, such as TOF camera 202 and camera device 204, one or more sensors 206 (e.g., an ultrasonic sensor, an inertial measurement unit, a depth sensor using any suitable technology for determining depth (e.g., based on TOF, structured light, or other depth sensing technique or system), a touch sensor, a RADAR sensor, a LIDAR sensor, a microphone, etc.), a storage 208, and one or more compute components 210. In some cases, the local computing device 110 can optionally include one or more other/additional sensors such as, for example and without limitation, a pressure sensor (e.g., a barometric air pressure sensor and/or any other pressure sensor), a humidity sensor, a motion sensor, a light sensor, a gyroscope, an accelerometer, a magnetometer, and/or any other sensor. In some examples, the local computing device 110 can include additional components such as, for example, a light-emitting diode (LED) device, a cache, a communications interface, a display, a memory device, etc. An example architecture and example hardware components that can be implemented by the local computing device 110 are further described below with respect to FIG. 14.

The local computing device 110 can be part of, or implemented by, a single computing device or multiple computing devices. In some examples, the local computing device 110 can be part of and/or include an electronic device (or devices) such as a computer system (e.g., a server, a laptop computer, a tablet computer, etc.), a camera system (e.g., a digital camera, an IP camera, a video camera, a security camera, etc.), a telephone system (e.g., a smartphone, a cellular telephone, a conferencing system, etc.), a display device, an XR device such as a head-mounted display (HMD), an IoT (Internet-of-Things) device, or any other suitable electronic device(s).

In some implementations, the TOF camera 202, the camera device 204, the one or more sensors 206, the storage 208, and/or the one or more compute components 210 can be part of the same computing device. For example, in some cases, the TOF camera 202, the camera device 204, the one or more sensors 206, the storage 208, and/or the one or more compute components 210 can be integrated with or into a server computer, a camera system, a laptop, a tablet computer, an XR device such as an HMD, an IoT device, and/or any other computing device. In other implementations, the TOF camera 202, the camera device 204, the one or more sensors 206, the storage 208, and/or the one or more compute components 210 can be part of, or implemented by, two or more separate computing devices.

The one or more compute components 210 of the local computing device 110 can include, for example and without limitation, a central processing unit (CPU) 212, a graphics processing unit (GPU) 214, a digital signal processor (DSP) 216, and/or an image signal processor (ISP) 218. In some examples, the local computing device 110 can include other processors or processing devices such as, for example, a computer vision (CV) processor, a neural network processor (NNP), an application-specific integrated circuit (ASIC), a field-programmable gate array (FPGA), etc. The local computing device 110 can use the one or more compute components 210 to perform various computing operations such as, for example, HDR and image processing functionalities as described herein, autonomous driving operations, extended reality operations (e.g., tracking, localization, object detection, classification, pose estimation, mapping, content anchoring, content rendering, etc.), detection (e.g., face detection, object detection, scene detection, human detection, etc.), image segmentation, device control operations, image/video processing, graphics rendering, machine learning, data processing, modeling, calculations, computer vision, and/or any other operations.

In some cases, the one or more compute components 210 can include other electronic circuits or hardware, computer software, firmware, or any combination thereof, to perform any of the various operations described herein. In some examples, the one or more compute components 210 can include more or less compute components than those shown in FIG. 2. Moreover, the CPU 212, the GPU 214, the DSP 216, and the ISP 218 are merely illustrative examples of compute components provided for explanation purposes.

In some examples, the TOF camera 202 can include a three-dimensional (3D) TOF camera and the camera device 204 can include any image and/or video sensor and/or image/video capture device, such as a digital camera sensor, a video camera sensor, a TOF camera sensor, an image/video capture device on an electronic apparatus such as a computer, a camera, etc. In some cases, the TOF camera 202 and/or the camera device 204 can be part of a camera system or computing device such as a digital camera, a video camera, an IP camera, a smartphone, a smart television, a game system, etc. Moreover, in some cases, the TOF camera 202 and the camera device 204 can include multiple image sensors, such as rear and front sensor devices, and can be part of a dual-camera or other multi-camera assembly (e.g., including two camera, three cameras, four cameras, or other number of cameras). In some examples, the TOF camera 202 and/or the camera device 204 can be part of a camera system.

In some examples, the TOF camera 202 and the camera device 204 can capture image data and generate frames based on the image data and/or provide the image data or frames to the one or more compute components 210 for processing. A frame can include a video frame of a video sequence or a still image. A frame can include a pixel array representing a scene. For example, a frame can be a red-green-blue (RGB) frame having red, green, and blue color components per pixel; a luma, chroma-red, chroma-blue (YCbCr) frame having a luma component and two chroma (color) components (chroma-red and chroma-blue) per pixel; or any other suitable type of color or monochrome picture.

The storage 208 can include any storage device(s) for storing data such as, for example and without limitation, image data, posture data, scene data, user data, preferences, etc. The storage 208 can store data from any of the components of the local computing device 110. For example, the storage 208 can store data or measurements from any of the TOF camera 202, the camera device 204, the one or more sensors 206, the compute components 210 (e.g., processing parameters, outputs, video, images, segmentation maps/masks, depth maps, filtering results, confidence maps, masks, calculation results, detection results, etc.), the data processing engine 220, and/or any other components. In some examples, the storage 208 can include a buffer for storing data (e.g., image data, posture data, etc.) for processing by the compute components 210.

The one or more compute components 210 can perform image/video processing, HDR functionalities, machine learning, depth estimation, XR processing, device management/control, detection (e.g., object detection, face detection, scene detection, human detection, etc.) and/or other operations as described herein using data from the TOF camera 202, the camera device 204, the one or more sensors 206, the storage 208, and/or any other sensors and/or components. In some examples, the one or more compute components 210 can implement one or more software engines and/or algorithms such as, for example, a data processing engine 220 or algorithm as described herein. In some cases, the one or more compute components 210 can implement one or more other or additional components and/or algorithms such as a machine learning model(s), a computer vision algorithm(s), a neural network(s), and/or any other algorithm and/or component.

The data processing engine 220 can implement one or more algorithms and/or machine learning models configured to generate HDR images, generate depth estimates, perform image processing, etc., as further described herein. In some examples, the data processing engine 220 can be configured to generate an HDR frame based on multiple exposures captured by the TOF camera 202.

The components shown in FIG. 2 with respect to the local computing device 110 are illustrative examples provided for explanation purposes. In other examples, the local computing device 110 can include more or less components than those shown in FIG. 2. While the local computing device 110 is shown to include certain components, one of ordinary skill will appreciate that the local computing device 110 can include more or fewer components than those shown in FIG. 2. For example, the local computing device 110 can include, in some instances, one or more memory devices (e.g., RAM, ROM, cache, and/or the like), one or more networking interfaces (e.g., wired and/or wireless communications interfaces and the like), one or more display devices, caches, storage devices, and/or other hardware or processing devices that are not shown in FIG. 2. An illustrative example of a computing device and/or hardware components that can be implemented with the local computing device 110 are described below with respect to FIG. 14.

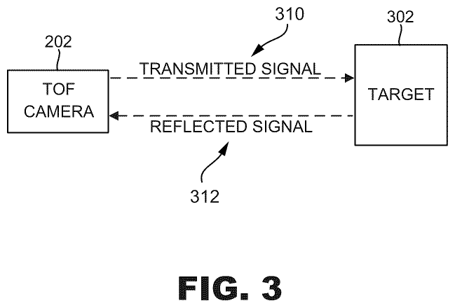

FIG. 3 is a diagram illustrating an example operation of a 3D TOF camera. In this example, the 3D TOF camera is the TOF camera 202 described above with respect to FIG. 2. In some examples, the TOF camera 202 can work by illuminating a scene with a modulated light source, and observing the reflected light. The TOF camera 202 can measure the phase shift between the illumination and the reflection and translate it to a distance measurement. In some cases, the illumination from the TOF camera 202 can be generated by a solid-state laser (e.g., a laser diode or LD, a vertical-cavity surface-emitting laser or VCSEL, etc.) or a light-emitting diode (LED) of the TOF camera 202. The solid-state laser or LED can operate in the infrared or near-infrared range, for example. An imaging sensor of the TOF camera 202 designed to respond to the same spectrum can receive the light and convert the photonic energy to electrons or electrical current and voltage. In some cases, the light entering the sensor of the TOF camera 202 can include an ambient component and a reflected component. However, the distance (e.g., depth) information may be embedded in the reflected component or may only be embedded in the reflected component. Therefore, a high ambient component can reduce the signal-to-noise ratio (SNR).

As shown in FIG. 3, the TOF camera 202 can emit a transmitted signal 310 towards a target 302 in a scene. The target 302 can include any type of target such as, for example and without limitation, a human, an animal, a vehicle, a tree, a building, a structure, an object, a surface, a device, and/or any other target. The transmitted signal 310 can include light emitted by the TOF camera 202 and used to illuminate the target 302. In some examples, the transmitted signal 310 can include modulated light. After the TOF camera 202 emits the transmitted signal 310, the transmitted signal 310 can reflect from the target 302, and the TOF camera 202 can receive a reflected signal 312, which can include light reflected from the target 302. The TOF camera 202 can determine a phase shift between the transmitted signal 310 and the reflected signal 312 and translate the correlation results at different phase shifts into a distance (e.g., depth) measurement.

In some cases, to detect a phase shift between the transmitted signal 310 and the reflected signal 312, the light generated by the TOF camera 202 (e.g., the transmitted signal 310) can be pulsed or modulated by a continuous-wave (CW), such as a sinusoid or square wave. In some examples, when using the pulsed method, the light source (e.g., transmitted signal 310) can illuminate for a period of time, and the reflected energy can be sampled at every pixel, in parallel, using multiple out-of-phase windows. The TOF camera 202 can measure electrical charges accumulated during the samples (e.g., Q1 and Q2) and the measured electrical charges to compute a distance of the target 302.

With the CW method, the TOF camera 202 can take multiple samples per measurement, with each sample phase-stepped by, e.g., 90 degrees, for a total of four samples. Using this technique, the TOF camera 202 can calculate the phase angle between illumination and reflection and the distance associated with the target 302. In some cases, a reflected amplitude (A) and an offset (B) can have an impact on the depth measurement precision or accuracy. Moreover, the TOF camera 202 can approximate the depth measurement variance. In some cases, the reflected amplitude (A) can be a function of the optical power, and the offset (B) can be a function of the ambient light and residual system offset.

In some examples, the TOF camera 202 can include an emitter that emits modulated light (e.g., transmitted signal 310) to illuminate the target 302, and a receiver that receives the light reflected from the target 302 and demodulates the received signal (e.g., received signal 312). When the received light arrives at a TOF sensor of the TOF camera 202 (e.g., through a lens of the TOF camera 202), each pixel of the TOF sensor can control a set of capacitors to synchronously accumulate charge in multiple phase windows. In this way, the TOF camera 202 can acquire raw TOF data. The TOF camera 202 can then process the raw data, where the time-of-flight is demodulated and used to calculate the distance from the TOF camera 202 to the target 302. In some cases, the TOF camera 202 can also generate an amplitude image and a grayscale image.

The distance demodulation can establish the basis for estimating depth by the TOF camera 202. In some cases, there can be multiple capacitors (e.g., CA, CB) and multiple integral windows with a phase difference π under each pixel of the TOF sensor of the TOF camera 202. In one sampling period, the capacitors can accumulate charge multiple times and demodulate the signal with the sampling results. This process is called differential correlation sampling (DCS). In an example implementation of a 4-DC S method, the capacitors can sample a signal four times at 0°, 90°, 180° and 270° phases. The TOF camera 202 can use the sample results to demodulate the phase shift between the emitted signal (e.g., transmitted signal 310) and the received signal (e.g., received signal 312). The TOF camera 202 can calculate the distance of the target 302 (relative to the TOF camera 202) based on the phase shift.

In some examples, the TOF camera 202 can measure a distance for every pixel to generate a depth map. A depth map can include a collection of 3D points (e.g., each point is also known as a voxel). In some cases, the depth map can be rendered in a two-dimensional (2D) representation or image. In other cases, a depth map can be rendered in a 3D space as a collection of points or point cloud. In some examples, the 3D points can be mathematically connected to form a mesh onto which a texture surface can be mapped.

In some aspects, the TOF camera 202 can generate a confidence map indicating an estimated likelihood that a signal is saturated. In some examples, the confidence map can be generated based on pixel-wise operations used to determine, for each pixel of a signal captured by the TOF camera 202, whether the pixel is saturated or not. For example, the TOF camera 202 can generate a mask representing a confidence map indicating whether each pixel of a correlation sample captured by the TOF camera 202 is saturated or not. In some examples, the TOF camera 202 can determine whether each pixel of a correlation sample captured by the TOF camera 202 is above an upper threshold (e.g., an oversaturation threshold) or below a lower threshold (e.g., an undersaturation threshold). If a pixel is above the upper threshold or below a lower threshold, the TOF camera 202 can set a confidence map value corresponding to that pixel to 0, indicating that such pixel is saturated. If the pixel is not above the upper threshold or below the lower threshold, the TOF camera 202 can set a confidence map value corresponding to that pixel to 1, indicating that such pixel is not saturated.

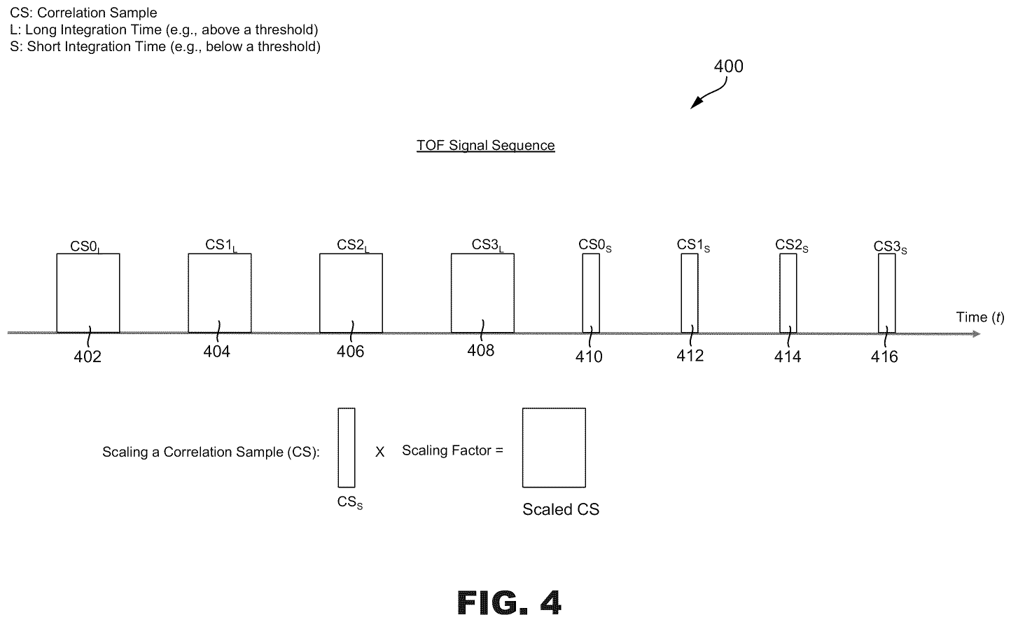

FIG. 4 is a diagram illustrating an example sequence 400 of TOF samples. In this example, the sequence 400 includes 4 correlation samples (also referred to as correlation signals or differential correlation signals (DCS)) with a long integration time (e.g., an integration time that exceeds a threshold) and 4 correlation samples with a short integration time (e.g., an integration time that is below a threshold). The integration times can include or refer to exposure times/amounts. For example, a correlation sample (CS) with a long integration time can include a CS with a long exposure, and a CS with a short integration time can include a CS with a short exposure.

As shown in FIG. 4, the sequence 400 includes a CS 402 with a long integration time, CS 404 with a long integration time, CS 406 with a long integration time, and CS 408 with a long integration time. The sequence 400 can also include CS 410 with a short integration time, CS 412 with a short integration time, CS 414 with a short integration time, and CS 416 with a short integration time. As further explained herein, in some cases, if a CS with a long integration time is saturated, the system can replace the saturated CS with an unsaturated CS with a short integration time. The unsaturated CS with the short integration time can be scaled (e.g., increased) based on a scaling factor. For example, if CS 402 is saturated but CS 410 is not saturated, the TOF camera 202 can scale the CS 410 and replace the CS 402 with the scaled CS 410.

In some examples, the scale factor can be calculated based on the integration times of the CS being replaced (e.g., CS 402) and the CS being used to replace the CS being replaced (e.g., CS 410). For example, in some cases, the scale factor can be calculated by dividing the long integration time of the CS 402 being replaced by the short integration time of the CS 410 replacing the CS 402. To illustrate, if the integration time of CS 402 is X and the integration time of CS 410 is Y, the scale factor can be calculated by dividing X by Y. Once the scale factor is calculated, the scaled CS can be generated by multiplying the CS that is being scaled (e.g., CS 410) by the scale factor. For example, the scaled CS can be generated by multiplying one or more values of the CS 410 by the scale factor.

In some cases, the systems and techniques described herein can increase a speed/efficiency of detecting saturated or partially-saturated correlation samples. For example, the systems and techniques described herein can implement a 4 phase shifting method with pairs of in and out of phase signals. A first pair of the in/out phase pairs can include CS 402 and CS 406, a second pair can include CS 404 and CS 408, a third pair can include CS 410 and CS 414, and a fourth pair can include CS 412 and CS 416. In this example, if CS 402 is saturated, then CS 406 will also be saturated given a relationship between CS 402 and CS 406, as further described herein. Thus, if CS 402 is saturated, CS 406 can be assumed/inferred to also be saturated. This feature can speed the saturation detection for the correlation samples, as it reduces the amount of saturation detection operations and allows some of the saturation detection results to be inferred from the saturation state of a relevant/corresponding correlation sample.

As another example, if CS 404 is saturated, then CS 408 will also be saturated given a relationship between CS 404 and CS 408. Thus, if CS 404 is saturated, CS 408 can be assumed/inferred to be also saturated and the process can otherwise skip performing a saturation detection for CS 408. If one or more correlation samples with long integration times is/are saturated, such saturated correlation samples can be replaced with unsaturated correlation samples with short integration times that are scaled using a scale factor as previously described. For example, if CS 402 is saturated and CS 410 is not saturated, CS 402 can be replaced with a scaled version of CS 410. Moreover, if CS 402 is saturated, CS 406 can be inferred to also be saturated based on a relationship (e.g., an inverse relationship) between CS 402 and CS 406. Accordingly, CS 406 can be replaced with a scaled version of CS 414, which is inferred to be unsaturated based on a relationship between CS 410 and CS 414.

In some examples, after detecting a saturation state of the correlation samples and replacing any saturated correlation sample from the set of correlation samples having long integration times with a scaled version of an unsaturated correlation sample having a short integration time, the TOF camera 202 can mix/fuse the correlation samples in the resulting sequence of correlation samples to generate an HDR frame. In some cases, the TOF camera 202 can apply weights to any of the correlation samples being mixed/fused to control how much each correlation sample influences the values of the HDR frame. The TOF camera 202 can add all the weighted correlation samples together to obtain an HDR frame with a maximum and/or optimized SNR.

In some examples, one or more of the correlation samples in the sequence 400 can be weighted using a weight(s) calculated based on the noise variance of the correlation samples. For example, a weight used to weight one or more correlation samples can be determined by dividing a noise variance value(s) associated with one or more correlation samples having a first integration time (e.g., a long integration time) by a sum of noise variance values associated with the one or more correlation samples and one or more additional correlation samples having a second integration time (e.g., the short integration time).

As previously noted, a sequence of correlation samples can include pairs of in-phase and out-of-phase correlation samples. Moreover, the relationship of correlation samples in pairs of correlation samples can be leveraged to increase the speed for detecting saturation of correlation samples and reduce the number of operations (and thus the burden on compute resources) used to detect saturation of correlation samples.

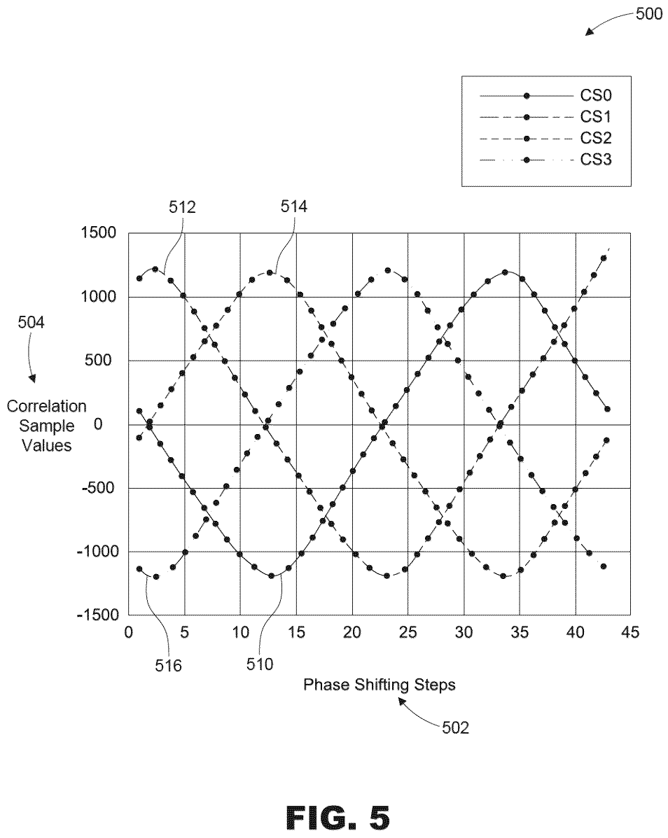

FIG. 5 is a chart illustrating pairs 500 of correlation samples and their respective relationships. The correlation samples in the chart are plotted along an axis of correlation sample values 504 and an axis of phase shifting steps 502. In this example, correlation sample 510 and correlation sample 514 form a pair of in phase and out-of-phase correlation samples, and correlation sample 512 and correlation sample 516 form another pair of in-phase and out-of-phase correlation samples.

As shown, correlation sample 510 and correlation sample 514 have an inverse relationship. Because of the inverse relationship of correlation sample 510 and correlation sample 514, if the system determines that correlation sample 510 is saturated, the system can infer that correlation sample 514 is also saturated. This inference can allow the system to detect a saturation (or lack thereof) of the correlation samples 510 and 514 faster as the system may perform an operation to detect a saturation (or lack thereof) of correlation sample 510 and infer the same result (e.g., saturation or no saturation) for correlation sample 514 rather than having to perform another detection operation to determine whether correlation sample 514 is saturated.

Similarly, correlation sample 512 and correlation sample 516 have an inverse relationship which the system can leverage to more quickly determine whether the correlation samples 512 and 516 are saturated. For example, because of the inverse relationship of correlation sample 512 and correlation sample 516, if the system determines that correlation sample 512 is saturated, the system can infer that correlation sample 516 is also saturated. This inference can allow the system to detect a saturation (or lack thereof) of the correlation samples 512 and 516 faster as the system may perform an operation to detect a saturation (or lack thereof) of correlation sample 512 and infer the same result (e.g., saturation or no saturation) for correlation sample 516 rather than having to perform another detection operation to determine whether correlation sample 516 is saturated.

As illustrated given the inverse relationships of correlation samples, if correlation sample 410 is determined to be saturated, correlation sample 414 can be inferred to also be saturated, and if correlation sample 412 is determined to be saturated, correlation sample 416 can be inferred to also be saturated. On the other hand, if correlation sample 410 is determined not to be saturated, an inference can be made that correlation sample 414 is not saturated, and if correlation sample 412 is determined not to be saturated, an inference can be made that correlation sample 416 is not saturated. By determining which correlation samples are saturated and which correlation samples are not saturated, the system can determine which correlation samples to include when merging/fusing correlation samples to produce an HDR frame, and which correlation samples should be replaced by scaled versions of unsaturated correlation samples.

For example, to increase the quality of the HDR frame, when mixing correlation samples to produce the HDR frame, the system can include any correlation samples that are not saturated. For any correlation samples that are saturated, the system can replace such correlation samples with other, unsaturated correlation samples, as previously explained. Before replacing saturated correlation samples with other, unsaturated correlation samples, the system can scale the unsaturated correlation samples as needed based on the integration times of the saturated correlation samples being replaced and the integration times of the unsaturated correlation samples being scaled and used to replace the saturated correlation samples.

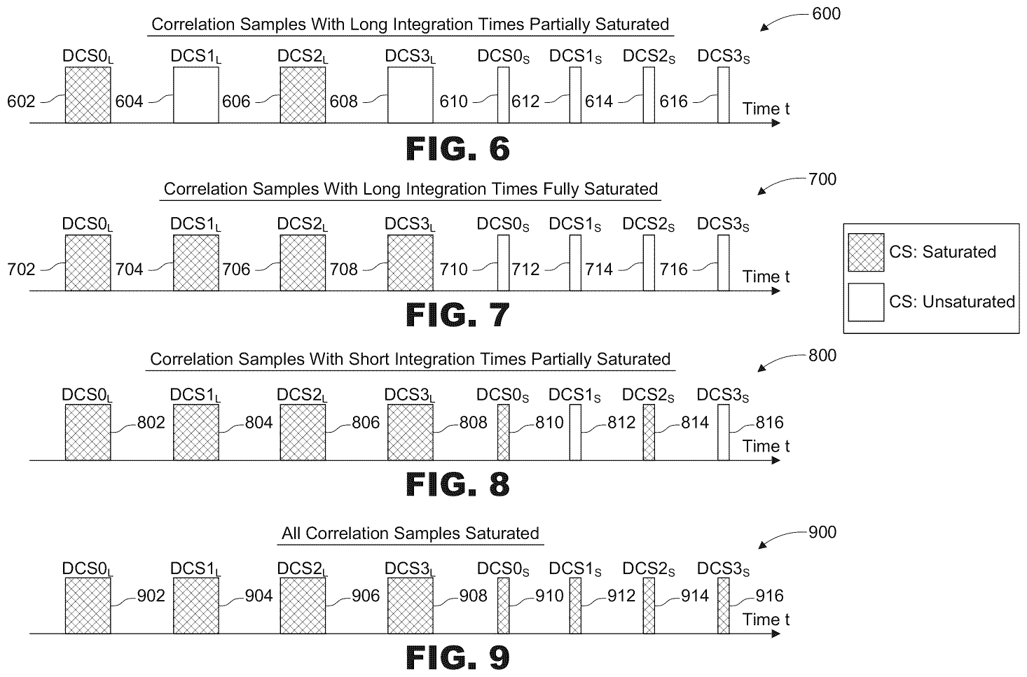

FIG. 6 is a diagram illustrating an example saturation scenario 600 including some saturated correlation samples and some unsaturated correlation samples. In this example, correlation samples 602 to 608 represent correlation samples with long integration times (e.g., integration times above a threshold) and correlation samples 610 to 616 represent correlation samples with short integration times (e.g., integration times below a threshold).

The system can process correlation sample 602 to determine whether correlation sample 602 is saturated. In this example, correlation sample 602 is saturated so the system can leverage the relationship between correlation sample 602 and correlation sample 606, which together form a pair of in-phase and out-of-phase correlation samples and have an inverse relationship, to infer that correlation sample 606 is also saturated. Thus, the system only needs to check one of the correlation samples 602 and 606 to make a saturation determination for both of the correlation samples 602 and 606.

The system can also process correlation sample 604 to determine whether correlation sample 604 is saturated. In this example, correlation sample 604 is not saturated so the system can keep correlation sample 604 in the set of correlation samples it mixes together to generate an HDR frame. In some examples, the system can also leverage the relationship between correlation sample 604 and correlation sample 608, which together form a pair of in-phase and out-of-phase correlation samples and have an inverse relationship, to infer that correlation sample 608 is also not saturated. Again, the system only needs to check one of the correlation samples 604 and 608 to make a saturation determination for both of the correlation samples 604 and 608.

As previously noted, the system can determine that correlation sample 610 is not saturated and infer that correlation sample 614 is also not saturated based on the relationship between the correlation sample 610 and the correlation sample 614, which together form a pair of in-phase and out-of-phase correlation samples. The system can also determine that correlation sample 612 is not saturated and infer that correlation sample 616 is also not saturated based on the relationship between the correlation sample 612 and the correlation sample 616, which together form a pair of in-phase and out-of-phase correlation samples.

Because correlation samples 602 and 606 are saturated, the system can replace them with unsaturated correlation samples. For example, the system can replace correlation sample 602 with correlation sample 610 (which is not saturated) and correlation sample 606 with correlation sample 614 (which is not saturated). Since correlation samples 610 and 614 have different integration times than correlation samples 602 and 606, the system can scale the correlation samples 610 and 614 based on the integration times of the correlation samples 602 and 606 being replaced and the integration times of the correlation samples 610 and 614 being used to replace the correlation samples 602 and 606. The system can then mix/fuse the scaled version of correlation sample 610 with correlation sample 610 (e.g., the unscaled version), correlation sample 604 with correlation sample 612, the scaled version of correlation sample 614 with correlation sample 614 (e.g., the unscaled version), and correlation sample 608 with correlation sample 616. In some examples, before mixing the correlation samples, the system can apply respective weights to the correlation samples to control how much each correlation sample contributes to the HDR frame generated based on the mixed correlation samples. In some examples of all the correlation samples having the long integration time and all the correlation samples having the short integration time being unsaturated, the system can apply respective weights to the correlation samples to control how much each correlation sample contributes to the HDR frame generated based on the correlation samples.

In some cases, the weights applied to correlation samples can be based on noise variances between correlation samples. For example, the weight for a correlation sample with a short integration time can be calculated by dividing a noise variance of the correlation sample with the short integration time by a sum of the noise variance of the correlation sample with the short integration time and the noise variance of a correlation sample with a long integration time. In some examples, the weight for a correlation sample with a short integration time can be calculated by dividing an integration time of the correlation sample with the short integration time by a sum of the integration time of the correlation sample with the short integration time and the integration time of a correlation sample with a long integration time.

Similarly, the weight for a correlation sample with a long integration time can be calculated by dividing a noise variance of the correlation sample with the long integration time by a sum of the noise variance of a correlation sample with a short integration time and the noise variance of the correlation sample with the long integration time. In some examples, the weight for a correlation sample with a long integration time can be calculated by dividing an integration time of the correlation sample with the long integration time by a sum of the integration time of the correlation sample with the long integration time and the integration time of a correlation sample with a short integration time.

In some cases, when mixing together correlation samples, the system can add a correlation sample with a long integration time (after applying a weight to the correlation sample) with a correlation sample with a short integration time (after applying a weight to the correlation sample) to yield a correlation sample mixed from a pair of correlation samples with long and short integration times. If a correlation sample with a long integration time was replaced by a scaled version of a correlation sample with a short integration time, the system can add the scaled version of the correlation sample with a corresponding (unsaturated) correlation sample with a short integration time. The system can mix each pair of correlation samples with long and short integration times to yield a set of mixed correlation samples. The system can then mix/fuse the mixed correlation samples together to yield an HDR frame.

For example, in FIG. 6, the system can mix the scaled version of correlation sample 610, which was used to replace correlation sample 602, with correlation sample 610. The system can apply weights to the scaled version of correlation sample 610 and the correlation sample 610 before mixing them together. The system can generate a first mixed correlation sample based on the mixing of the scaled and weighted version of correlation sample 610 and the weighted version of correlation sample 610. The system can also mix a weighted version of correlation sample 604 with a weighted version of correlation sample 612 to yield a second mixed correlation sample.

Moreover, the system can mix the scaled version of correlation sample 614, which was used to replace correlation sample 606, with correlation sample 614. The system can apply weights to the scaled version of correlation sample 614 and the correlation sample 614 before mixing them together. The system can generate a third mixed correlation sample based on the mixing of the scaled and weighted version of correlation sample 614 and the weighted version of correlation sample 614. The system can also mix a weighted version of correlation sample 608 with a weighted version of correlation sample 616 to yield a fourth mixed correlation sample.

The system can then mix/fuse the first, second, third, and fourth mixed correlation samples to produce the HDR frame. The HDR frame will have a better quality than an HDR frame otherwise generated by mixing the correlation samples 602 to 616 without weighting and replacing the saturated correlation samples (e.g., correlation samples 602 and 606) as previously described. The speed of the process for detecting saturated correlation samples will also be increased by leveraging the relationship of correlation samples to infer saturation detection results for some of the correlation samples.

In some cases, if all the correlation samples (e.g., correlation samples 602 to 616) are determined to be unsaturated, the system can mix all of the weighted correlation samples together without replacing any correlation samples. Moreover, additional examples where more than two correlation samples are saturated are further described below.

FIG. 7 is a diagram illustrating another example saturation scenario 700. In this example, correlation samples 702 to 708 represent correlation samples with long integration times (e.g., integration times above a threshold) and correlation samples 710 to 716 represent correlation samples with short integration times (e.g., integration times below a threshold). The correlation samples 702 to 708 with long integration times are all saturated, and the correlation samples 710 to 716 with short integration times are all unsaturated.

The system can process correlation sample 702 to determine whether correlation sample 702 is saturated. As shown, correlation sample 702 is saturated, so the system can leverage the relationship between correlation sample 702 and correlation sample 706, which together form a pair of in-phase and out-of-phase correlation samples and have an inverse relationship, to infer that correlation sample 706 is also saturated. Thus, the system only needs to check one of the correlation samples 702 and 706 to make a saturation determination for both of the correlation samples 702 and 706.

The system can also process correlation sample 704 to determine whether correlation sample 704 is saturated. Here, the correlation sample 704 is saturated so the system can leverage the relationship between correlation sample 704 and correlation sample 708, which together form a pair of in-phase and out-of-phase correlation samples and have an inverse relationship, to infer that correlation sample 708 is also saturated. Again, the system only needs to check one of the correlation samples 704 and 708 to make a saturation determination for both of the correlation samples 704 and 708.

The system can determine that correlation samples 710 to 716 are not saturated. Because correlation samples 702 to 708 are saturated, the system can replace correlation sample 702 with a scaled version of correlation sample 710 (which is not saturated), correlation sample 704 with a scaled version of correlation sample 712 (which is not saturated), correlation sample 706 with a scaled version of correlation sample 714 (which is not saturated), and correlation sample 708 with a scaled version of correlation sample 716 (which is not saturated).

Since correlation samples 710 to 716 have different integration times than correlation samples 702 and 708, the system can scale the correlation samples 710 to 716 based on the integration times of the correlation samples 702 to 708 being replaced and the integration times of the correlation samples 710 to 716 to keep the active brightness of the image consistent. The system can then mix together the scaled version of correlation sample 710 and correlation sample 710, the scaled version of correlation sample 712 and correlation sample 712, the scaled version of correlation sample 714 and correlation sample 714, and the scaled version of correlation sample 716 and correlation sample 716. As previously explained, the system can apply a weight to each of the correlation samples being mixed prior to mixing (e.g., adding) the correlation samples. The system can then mix/fuse together the mixed correlation samples to yield an HDR frame.

For example, the system can mix/fuse together a first mixed correlation sample generated based on the scaled version of correlation sample 710 and correlation sample 710, a second mixed correlation sample generated based on the scaled version of correlation sample 712 and correlation sample 712, a third mixed correlation sample generated based on the scaled version of correlation sample 714 and correlation sample 714, and a fourth mixed correlation sample generated based on the scaled version of correlation sample 716 and correlation sample 716. As previously explained, the system can apply a weight to each of the correlation samples being mixed prior to mixing (e.g., adding) the correlation samples.

FIG. 8 is a diagram illustrating another example saturation scenario 800. In this example, correlation samples 802 to 808 represent correlation samples with long integration times (e.g., integration times above a threshold) and correlation samples 810 to 816 represent correlation samples with short integration times (e.g., integration times below a threshold). The correlation samples 802 to 808 with long integration times are all saturated. On the other hand, the correlation samples with the short integration time are partially saturated. More specifically, the correlation samples 810 and 814 are saturated, and the correlation samples 812 and 816 are unsaturated.

In some cases, because all of the correlation samples with long integration times (e.g., correlation samples 802 to 808) are saturated and only the correlation samples 812 and 816 from the correlation samples with short integration times are unsaturated, the system may not use the correlation samples 802 to 816 to generate an HDR frame as previously described. Instead, the system may generate a report indicating that all of the correlation samples with long integration times (e.g., correlation samples 802 to 808) are saturated and only the correlation samples 812 and 816 from the correlation samples with short integration times are unsaturated. Additionally or alternatively, the system can wait until more correlation samples are generated to try to generate an HDR frame. In some examples, the system may try to obtain additional correlation samples until at least half of the correlation samples are unsaturated. For example, the system can continue obtaining correlation samples until it obtains at least four unsaturated correlation samples as shown in scenarios 600 and 700 shown in FIG. 6 or 7.

In other cases, the system may use the unsaturated correlation samples 812 and 816 to generate an HDR frame. For example, the system can replace the correlation samples 802 to 808 with scaled versions of the correlation sample 812 and/or the correlation sample 816. The system can then apply weights to the scaled correlation samples and the correlation samples 812 and 816, and mix the correlation samples into a set of correlation samples. The system can then mix the set of correlation samples as previously described to generate an HDR frame.

FIG. 9 is a diagram illustrating another example saturation scenario 900. The correlation samples 902 to 908 represent correlation samples with long integration times (e.g., integration times above a threshold) and correlation samples 910 to 916 represent correlation samples with short integration times (e.g., integration times below a threshold). In this example, the correlation samples 902 to 908 with long integration times are all saturated, and the correlation samples 910 to 916 with short integration times are also saturated. Thus, all the correlation samples are saturated. Accordingly, the system does not have enough unsaturated correlation samples to generate an HDR frame.

In some examples, the system can generate a report indicating that all of the correlation samples are saturated and/or indicating that there are not enough unsaturated correlation samples to generate an HDR frame. In some cases, the system can obtain additional correlation samples until the system detects enough unsaturated correlation samples to generate an HDR frame. For example, the system can obtain additional correlation samples until it obtains enough unsaturated correlation samples as shown in scenarios 600 or 700 shown in FIG. 6 or 7.

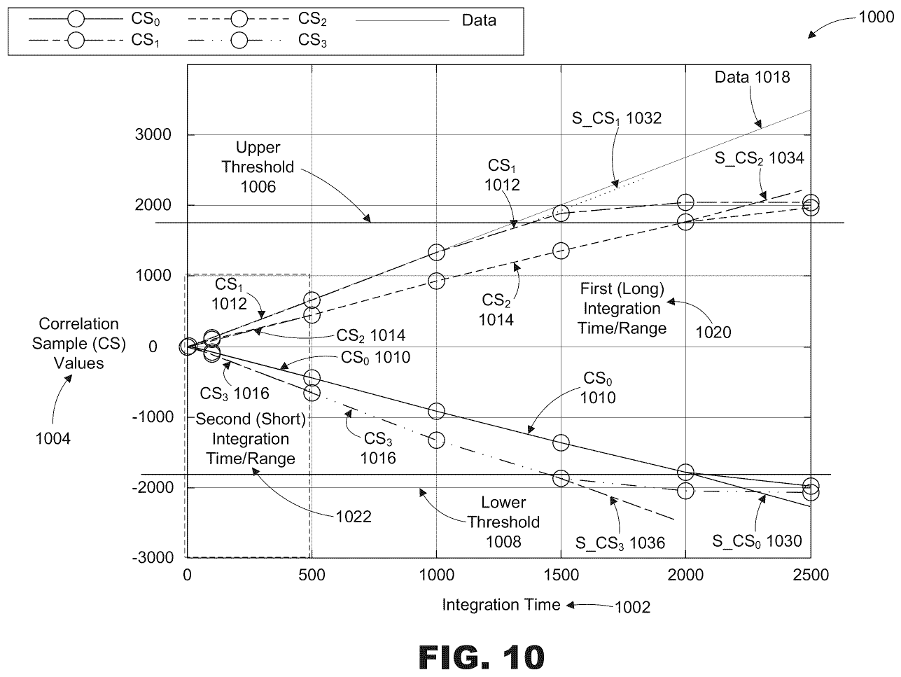

FIG. 10 is a chart illustrating an example enhanced TOF HDR pipeline 1000, in accordance with some examples of the present disclosure. The chart includes an axis representing integration times 1002 of correlation samples and an axis representing correlation sample values 1004. The chart plots correlation samples 1010 to 1016 along the integration times 1002 and the correlation sample values 1004. The chart also plots data 1018 along the axis of integration times 1002 and the axis of correlation sample values 1004. Moreover, the chart depicts a threshold 1006 and a threshold 1008 for determining whether correlation samples are saturated. For example, if a value of a correlation sample exceeds the threshold 1006 or is below the threshold 1008, the system can determine that the correlation sample is saturated as it exceeds the threshold 1006 or is below the threshold 1008.

In some examples, the correlation samples can include a long integration time 1020 and a short integration time 1022. The system can use the thresholds 1006 and 1008 to identify which correlation samples are saturated and which correlation samples are unsaturated. Any correlation samples with long integration times that are saturated can be replaced with scaled versions of unsaturated correlation samples with short integration times.

In some examples, the system can scale one or more correlation samples with short integration times and use the scaled correlation samples to replace correlation samples with long integration times that are saturated (e.g., above threshold 1006 or below threshold 1008). The system can replace the saturated correlation samples with long integration times with the one or more scaled correlation samples.

For example, the system can generate scaled correlation sample 1030 by scaling the correlation sample 1010 with short integration time. The scaled correlation sample 1030 can be stretched to include a long integration time. The system can generate scaled correlation sample 1032 by scaling the correlation sample 1012 with short integration time. The scaled correlation sample 1032 can be stretched to include a long integration time.

The system can generate scaled correlation sample 1034 by scaling the correlation sample 1014 with short integration time. The scaled correlation sample 1034 can be stretched to include a long integration time. Finally, the system can generate scaled correlation sample 1036 by scaling the correlation sample 1016 with short integration time. The scaled correlation sample 1036 can be stretched to include a long integration time. The system can then mix the correlation samples with short integration times with any of the correlation samples having long integration times that are not saturated or any of the scaled correlation samples that have been stretched to include long integration times. In some cases, the system can apply weights to the correlation samples being mixed prior to mixing the correlation samples, as previously described.

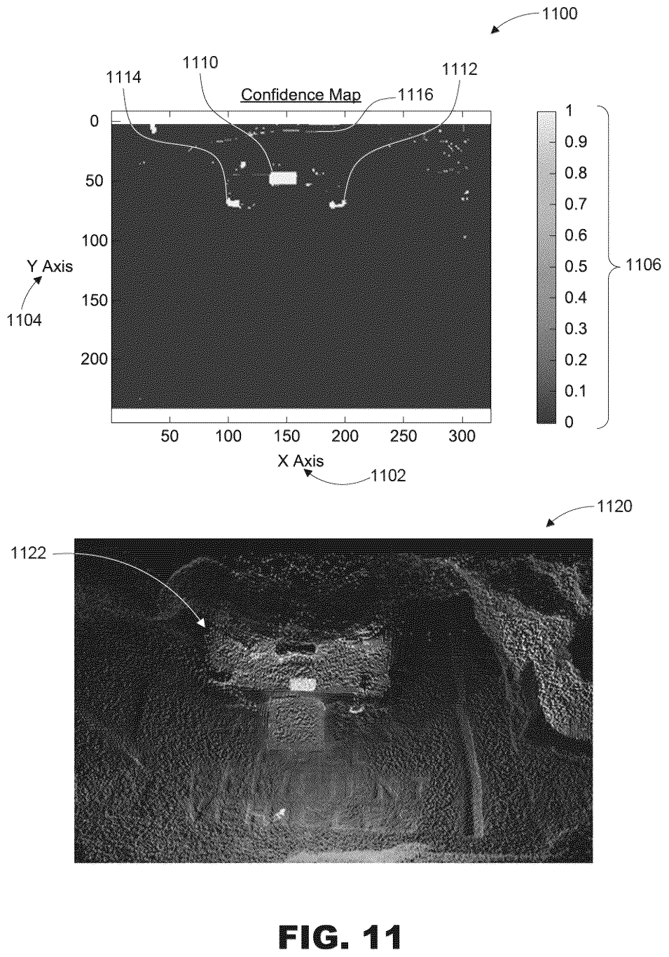

FIG. 11 illustrates an example confidence map 1100 corresponding to a point cloud 1120 (or depth map) generated in accordance with some examples of the present disclosure. The point cloud 1120 includes a vehicle 1122 in a scene. In some examples, the point cloud 1120 can be generated by mixing multiple correlation samples to produce an HDR frame as described herein.

The confidence map 1100 uses mask values to indicate an estimated confidence or likelihood that specific pixels in the point cloud 1120 are saturated or unsaturated. The mask values in this example range from 0 to 1, with 0 representing a highest confidence that a pixel is not saturated, and 1 representing a highest confidence that the pixel is saturated.

In some examples, the confidence map 1100 can include a mask created based on every pixel of one or more correlation samples with short integration times. In other examples, the confidence map 1100 can include a mask created based on every pixel of any correlation samples such as, for example, all or a subset of correlation samples with short integration times used to produce the point cloud 1120 and/or all or a subset of correlation samples with long integration times used to produce the point cloud 1120.

In some cases, to generate the confidence map 1100, the system can analyze each pixel of one or more correlation samples (e.g., all or a subset of correlation samples with short integration times) to determine if the pixel is saturated or not. For example, the system can determine the pixel value of each pixel of one or more correlation samples and determine whether the pixel is saturated or unsaturated based on the pixel value. If a pixel is determined to be saturated, the system can assign that pixel a value of 1, and if a pixel is determined to be unsaturated, the system can assign that pixel a value of 0. The values of 0 and 1 can produce a mask representing a confidence that the pixels of the one or more correlation samples are saturated or not. In some cases, the mask can include values between 0 and 1. For example, the value assigned for a pixel can be greater than 0 and less than 1 depending on the confidence that the pixel is saturated or not. In such examples, a value below 0.5 indicates that the system is more confident than not that the pixel is not saturated, and a value above 0.5 can indicate that the system is more confident than not that the pixel is saturated.

As shown in FIG. 11, the confidence map 1100 includes a range of mask values 1106 used to indicate a confidence that specific pixels are saturated or not. The confidence map 1100 includes an X axis 1102 and a Y axis 1104 used to identify the location of each pixel within the confidence map 1100. In this example, the confidence map 1100 includes portions determined to be saturated (e.g., portions having mask values of 1 or more than 0.5), such as regions 1110 to 1114, and portions determined to be unsaturated (e.g., portions having mask values of 0 or less than 0.5), such as region 1116.

The saturated portions in the confidence map 1100 (e.g., regions 1110, 1112, and 1114) include a license plate of a vehicle in the depth map 1120 and other portions of the vehicle. The pixels corresponding to such portions of the vehicle can be saturated based on one or more factors such as, for example, an amount of illumination of such portions (e.g., darker than a threshold, brighter than a threshold, etc.), a reflectance of a portion of a scene, etc. For example, the region 1110 representing a license plate of the vehicle may be saturated because of a reflectance of the license plate.

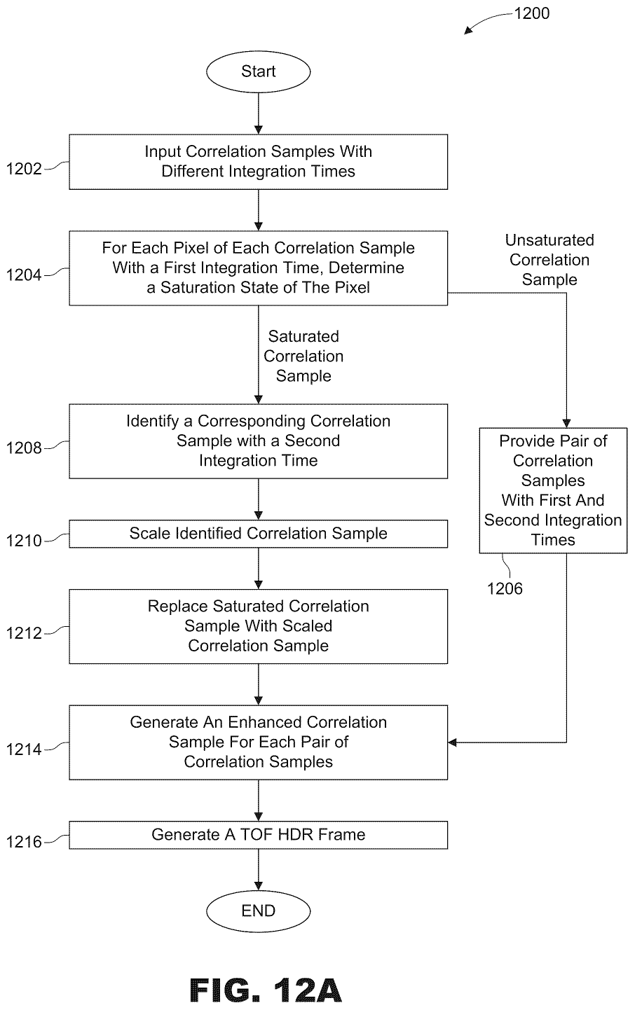

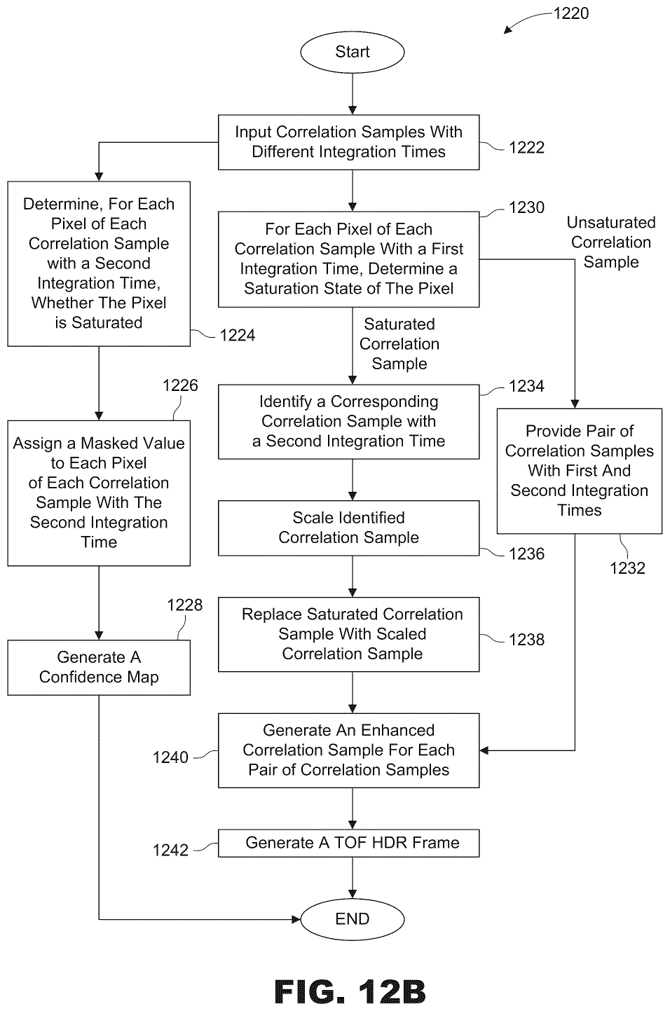

FIG. 12A is a flowchart illustrating an example process 1200 for generating a TOF HDR frame. At block 1202, the process 1200 can include obtaining an input including correlation samples with different integration times. For example, the input can include all available correlation samples with long integration times (e.g., 2 in cases involving 2 sets of 2 correlation samples, 4 in cases involving 2 sets of 4 correlation samples, etc.) and one or more correlation samples with short integration times.

At block 1204, the process 1200 can include determining, for each pixel of each correlation sample with a first integration time (e.g., a long integration time), a saturation state of the pixel. The saturation state can include saturated or unsaturated. For example, in some cases, the system can determine, for each pixel of each correlation sample with the first integration time, whether the pixel is saturated or not.

At block 1206, if none of the pixels of a correlation sample with the first integration time are saturated, the process 1200 can include providing the correlation sample with the first integration time and a corresponding correlation sample with a second integration time (e.g., short integration time) to block 1214, where the process 1200 uses the pair of correlation samples to generate enhanced correlation samples.

At block 1208, if a correlation sample with the first integration time is at least partially saturated, the process 1200 can include identifying a corresponding correlation sample with the second integration time. The process 1200 can identify the corresponding correlation sample in order to scale the correlation sample with the second integration time and replace the saturated correlation sample with the first integration time with the scaled correlation sample, as further described below.

At block 1210, the process 1200 can include scaling the identified correlation sample with the second integration time. In some examples, the process 1200 can scale the correlation sample with the second integration time by dividing the first integration time (e.g., the long integration time) by the second integration time (e.g., the short integration time), and applying the result to the correlation sample with the second integration time. For example, the process 1200 can divide the first integration time by the second integration time, and adjust the size of the correlation sample with the second integration time based on the result. As another example, the process 1200 can divide the first integration time by the second integration time, and multiply values of the correlation sample with the second integration time by the result of the division.

At block 1212, the process 1200 can include replacing the saturated correlation sample with the scaled correlation sample from block 1210.

At block 1214, the process 1200 can include generating an enhanced correlation sample for each pair of correlation samples. A pair of correlation samples can include an unsaturated correlation sample with the first integration time and an unsaturated correlation sample with the second integration time, or a scaled correlation sample from block 1210 and an unsaturated correlation sample with the second integration time.

For example, assume for illustrative purposes that the correlation samples include a scaled correlation sample 0, a correlation sample 1 with the first integration time, a scaled correlation sample 2, a correlation sample 3 with the first integration time, and correlation samples 0 to 3 with the second integration times. In this example, the process 1200 can generate an enhanced correlation sample using scaled correlation sample 0 and correlation sample 0 with the second integration time, another enhanced correlation sample using correlation sample 1 with the first integration time and correlation sample 1 with the second integration time, another enhanced correlation sample using scaled correlation sample 2 and correlation sample 2 with the second integration time, and another enhanced correlation sample using correlation sample 3 with the first integration time and correlation sample 3 with the second integration time.

To generate an enhanced correlation sample based on a pair of correlation samples, the process 1200 can mix the correlation samples in the pair to generate a single, enhanced correlation sample based on the pair of correlation samples. To illustrate using the previous example, to generate an enhanced correlation sample based on a pair that includes scaled correlation sample 0 and correlation sample 0 with the second integration time, the process 1200 can mix the scaled correlation sample 0 with the correlation sample 0 with the second integration time to produce an enhanced correlation sample. Similarly, to generate an enhanced correlation sample based on a pair that includes correlation sample 1 with the first integration time and correlation sample 1 with the second integration time, the process 1200 can mix the correlation sample 1 with the first integration time with the correlation sample 1 with the second integration time to produce an enhanced correlation sample.

In some examples, when mixing correlation samples in a pair of correlation samples, the process 1200 can apply weight to each correlation sample before mixing the correlation samples. For example, before mixing correlation sample 1 with the first integration time and correlation sample 1 with the second integration time, the process 1200 can apply a weight to the correlation sample 1 with the first integration time and a weight to the correlation sample 1 with the second integration time. The process 1200 can then mix the weighted correlation samples.

The weights can control how much each correlation sample influences the values of the enhanced correlation sample. For example, a lower weight applied to a correlation sample will cause that correlation sample to have less influence on the enhanced correlation sample than another correlation sample with a higher weight. In some cases, a lower weight can be applied to a correlation sample that has lower quality to reduce the impact of that correlation sample on the enhanced correlation sample, and a higher weight can be applied to a correlation sample that has higher quality to increase the impact of that correlation sample on the enhanced correlation sample.

At block 1214, the process 1200 can include generating a TOF HDR frame based on the enhanced correlation samples. To generate the TOF HDR frame, the process 1200 can mix the enhanced correlation samples into a single HDR frame. In some examples, the enhanced correlation samples can include an enhanced correlation sample for each pair of correlation samples. For example, if there are 4 pairs of correlation samples, the process 1200 may generate 4 enhanced correlation samples, which the process 1200 can mix together to generate the TOF HDR frame. As another example, if there are 2 pairs of correlation samples, the process 1200 may generate 2 enhanced correlation samples, which the process 1200 can mix together to generate the TOF HDR frame.

FIG. 12B is a flowchart illustrating an example process 1220 for generating a TOF HDR frame and a confidence map. At block 1222, the process 1220 can include obtaining an input including correlation samples with different integration times. For example, the input can include all available correlation samples with long integration times (e.g., 2 in cases involving 2 sets of 2 correlation samples, 4 in cases involving 2 sets of 4 correlation samples, etc.) and one or more correlation samples with short integration times.

At block 1224, the process 1220 can include determining, for each pixel of each correlation sample with a second integration time (e.g., a short integration time), whether the pixel is saturated. For example, the process 1220 can determine, for each pixel of each correlation sample with the second integration time, whether a value of the pixel exceeds a saturation threshold.

At block 1226, the process 1220 can include assigning each pixel of each correlation sample with the second integration time a mask value. For example, if at block 1224 the process 1220 determines that a pixel is saturated (e.g., a value of the pixel exceeds a saturation threshold), the process 1220 can assign that pixel a mask value of 1, and if at block 1224 the process 1220 determines that the pixel is not saturated (e.g., a value of the pixel is below a saturation threshold), the process 1220 can assign that pixel a mask value of 0.

At block 1228, the process 1220 can include generating a confidence map based on the mask values determined at block 1226. For example, the process 1220 can generate a confidence map depicting a masked representation of the pixel values. Each pixel in the masked representation with a masked value of 1 can be depicted with a certain characteristic and/or color indicating that the pixel is saturated, and each pixel in the masked representation with a masked value of 0 can be depicted with a different characteristic and/or color indicating that the pixel is not saturated.

In addition, at block 1230, the process 1220 can include determining, for each pixel of each correlation sample with a first integration time (e.g., a long integration time), a saturation state of the pixel. The saturation state can include saturated or unsaturated. For example, in some cases, the system can determine, for each pixel of each correlation sample with the first integration time, whether the pixel is saturated or not.

At block 1232, if none of the pixels of a correlation sample with the first integration time are saturated, the process 1220 can include providing the correlation sample with the first integration time and a corresponding correlation sample with a second integration time (e.g., short integration time) to block 1240, where the process 1220 uses the pair of correlation samples to generate enhanced correlation samples.

At block 1234, if a correlation sample with the first integration time is at least partially saturated, the process 1220 can include identifying a corresponding correlation sample with the second integration time. The process 1220 can identify the corresponding correlation sample in order to scale the correlation sample with the second integration time and replace the saturated correlation sample with the first integration time with the scaled correlation sample, as further described below.

At block 1236, the process 1220 can include scaling the identified correlation sample with the second integration time. In some examples, the process 1220 can scale the correlation sample with the second integration time by dividing the first integration time (e.g., the long integration time) by the second integration time (e.g., the short integration time), and applying the result to the correlation sample with the second integration time. For example, the process 1220 can divide the first integration time by the second integration time, and adjust the size of the correlation sample with the second integration time based on the result. As another example, the process 1220 can divide the first integration time by the second integration time, and multiply values of the correlation sample with the second integration time by the result of the division.

At block 1238, the process 1220 can include replacing the saturated correlation sample with the scaled correlation sample from block 1210.

At block 1240, the process 1220 can include generating an enhanced correlation sample for each pair of correlation samples. A pair of correlation samples can include an unsaturated correlation sample with the first integration time and an unsaturated correlation sample with the second integration time, or a scaled correlation sample from block 1210 and an unsaturated correlation sample with the second integration time.

For example, assume for illustrative purposes that the correlation samples include a scaled correlation sample 0, a correlation sample 1 with the first integration time, a scaled correlation sample 2, a correlation sample 3 with the first integration time, and correlation samples 0 to 3 with the second integration times. In this example, the process 1220 can generate an enhanced correlation sample using scaled correlation sample 0 and correlation sample 0 with the second integration time, another enhanced correlation sample using correlation sample 1 with the first integration time and correlation sample 1 with the second integration time, another enhanced correlation sample using scaled correlation sample 2 and correlation sample 2 with the second integration time, and another enhanced correlation sample using correlation sample 3 with the first integration time and correlation sample 3 with the second integration time.

To generate an enhanced correlation sample based on a pair of correlation samples, the process 1220 can mix the correlation samples in the pair to generate a single, enhanced correlation sample based on the pair of correlation samples. To illustrate using the previous example, to generate an enhanced correlation sample based on a pair that includes scaled correlation sample 0 and correlation sample 0 with the second integration time, the process 1220 can mix the scaled correlation sample 0 with the correlation sample 0 with the second integration time to produce an enhanced correlation sample. Similarly, to generate an enhanced correlation sample based on a pair that includes correlation sample 1 with the first integration time and correlation sample 1 with the second integration time, the process 1220 can mix the correlation sample 1 with the first integration time with the correlation sample 1 with the second integration time to produce an enhanced correlation sample.

In some examples, when mixing correlation samples in a pair of correlation samples, the process 1220 can apply weight to each correlation sample before mixing the correlation samples. For example, before mixing correlation sample 1 with the first integration time and correlation sample 1 with the second integration time, the process 1220 can apply a weight to the correlation sample 1 with the first integration time and a weight to the correlation sample 1 with the second integration time. The process 1220 can then mix the weighted correlation samples.

The weights can control how much each correlation sample influences the values of the enhanced correlation sample. For example, a lower weight applied to a correlation sample will cause that correlation sample to have less influence on the enhanced correlation sample than another correlation sample with a higher weight. In some cases, a lower weight can be applied to a correlation sample that has lower quality to reduce the impact of that correlation sample on the enhanced correlation sample, and a higher weight can be applied to a correlation sample that has higher quality to increase the impact of that correlation sample on the enhanced correlation sample.

At block 1242, the process 1220 can include generating a TOF HDR frame based on the enhanced correlation samples. To generate the TOF HDR frame, the process 1220 can mix the enhanced correlation samples into a single HDR frame. In some examples, the enhanced correlation samples can include an enhanced correlation sample for each pair of correlation samples. For example, if there are 4 pairs of correlation samples, the process 1220 may generate 4 enhanced correlation samples, which the process 1220 can mix together to generate the TOF HDR frame. As another example, if there are 2 pairs of correlation samples, the process 1220 may generate 2 enhanced correlation samples, which the process 1220 can mix together to generate the TOF HDR frame.

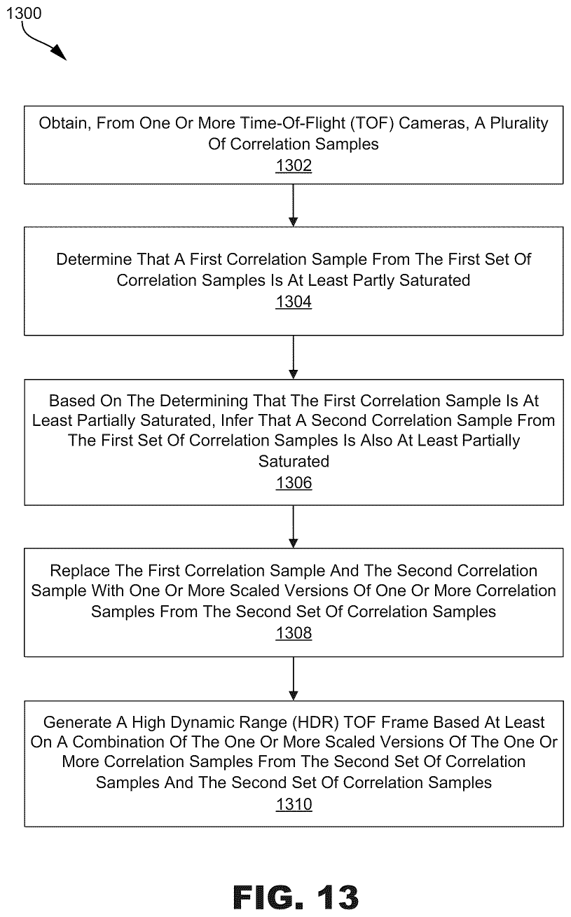

FIG. 13 is a flowchart illustrating an example process 1300 for implementing HDR with TOF cameras. At block 1302, the process 1300 can include obtaining, from one or more TOF cameras, a plurality of correlation samples. In some examples, the plurality of correlation samples can include a first set of correlation samples with a first integration time (e.g., long integration time) and a second set of correlation samples with a second integration time (e.g., short integration time).

At block 1304, the process 1300 can include determining that a first correlation sample from the first set of correlation samples is at least partly saturated. In some examples, determining that a first correlation sample from the first set of correlation samples is at least partly saturated can include determining, for each pixel of the first correlation sample, whether a value of the pixel is above a saturation threshold or below an additional saturation threshold.

At block 1306, the process 1300 can include inferring, based on the determining that the first correlation sample is at least partly saturated, that a second correlation sample from the first set of correlation samples is also at least partly saturated. In some examples, inferring that the second correlation sample from the first set of correlation samples is also at least partly saturated is based on an inverse relationship between the first correlation sample and the second correlation sample.

In some cases, the first correlation sample and the second correlation sample include a pair of in phase and out-of-phase correlation samples, and inferring that the second correlation sample from the first set of correlation samples is also at least partly saturated is based on an in phase and out-of-phase relationship of the pair of in phase and out-of-phase correlation samples.

At block 1308, the process 1300 can include replacing the first correlation sample and the second correlation sample with one or more scaled versions of one or more correlation samples from the second set of correlation samples.

At block 1310, the process 1300 can include generating an HDR TOF frame based at least on a combination of the one or more scaled versions of the one or more correlation samples from the second set of correlation samples and the second set of correlation samples.

In some aspects, the process 1300 can include scaling the one or more correlation samples from the second set of correlation samples to yield the one or more scaled versions of the one or more correlation samples. In some examples, the one or more correlation samples are scaled based on the first integration time and the second integration time. In some examples, scaling the one or more correlation samples includes dividing a first value of the first integration time by a second value of the second integration time.

In some aspects, the process 1300 can include, prior to generating the HDR TOF frame, determining a first pair of correlation samples and a second pair of correlation samples; applying a respective weight to each of the correlation samples in the first pair of correlation samples and the second pair of correlation samples; mixing the weighted correlation samples in the first pair of correlation samples to yield a first enhanced correlation sample; and mixing the weighted correlation samples in the second pair of correlation samples to yield a second enhanced correlation sample. In some examples, the first pair of correlation samples includes the one or more scaled versions of the one or more correlation samples and a corresponding correlation sample from the second set of correlation samples, and the second pair of correlation samples includes an additional correlation sample and an additional corresponding correlation sample from the second set of correlation samples.

In some cases, generating the HDR TOF frame includes mixing the first enhanced correlation sample and the second enhanced correlation sample.

In some examples, the respective weight associated with a particular correlation sample having one of the first integration time or the second integration time is determined by dividing a noise variance of the particular correlation sample by a result of adding the noise variance of the particular correlation sample with an additional noise variance of an addition correlation sample having a different one of the first integration time or the second integration time.

In some aspects, the process 1300 can include determining, for each correlation sample from the second set of correlation samples, whether the correlation sample is at least partially saturated; and generating a confidence map based on the determining whether the correlation sample is at least partially saturated. In some examples, the confidence map includes a representation of mask values associated with pixels of the correlation sample.

In some aspects, the process 1300 can include generating, by a computer (e.g., local computing device 110) of an autonomous vehicle (e.g., AV 102) based on the HDR TOF frame, depth information associated with a scene. In some examples, the depth information can include depth values indicating a respective depth of one or more portions of the scene relative to a location (and/or position) of the one or more TOF cameras within the scene. In some aspects, the process 1300 can include tracking, based on one or more HDR TOF frames, a depth of one or more locations in the scene associated with the one or more TOF cameras. In some examples, the one or more HDR TOF frames can include the HDR TOF frame. In some cases, the depth of the one or more locations in the scene is relative to a position of the one or more TOF cameras within the scene.

FIG. 14 illustrates an example processor-based system with which some aspects of the subject technology can be implemented. For example, processor-based system 1400 can be any computing device making up internal computing system 110, remote computing system 190, a passenger device executing the ridesharing application 170, or any component thereof in which the components of the system are in communication with each other using connection 1405. Connection 1405 can be a physical connection via a bus, or a direct connection into processor 1410, such as in a chipset architecture. Connection 1405 can also be a virtual connection, networked connection, or logical connection.

In some examples, computing system 1400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1400 includes at least one processing unit (CPU or processor) 1410 and connection 1405 that couples various system components including system memory 1415, such as read-only memory (ROM) 1420 and random-access memory (RAM) 1425 to processor 1410. Computing system 1400 can include a cache of high-speed memory 1412 connected directly with, in close proximity to, and/or integrated as part of processor 1410.

Processor 1410 can include any general-purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 can include an input device 1445, which can represent any number of input mechanisms, such as a microphone for speech, a touch-sensitive screen for gesture or graphical input, keyboard, mouse, motion input, speech, etc. Computing system 1400 can also include output device 1435, which can be one or more of a number of output mechanisms known to those of skill in the art. In some instances, multimodal systems can enable a user to provide multiple types of input/output to communicate with computing system 1400. Computing system 1400 can include communications interface 1440, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 1430 can include software services, servers, services, etc., that when the code that defines such software is executed by the processor 1410, causes the system to perform a function. In some examples, a hardware service that performs a particular function can include the software component stored in a computer-readable medium in connection with the necessary hardware components, such as processor 1410, connection 1405, output device 1435, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:
Aspect 1. A system comprising: a memory; and one or more processors coupled to the memory, the one or more processors being configured to: obtain, from one or more time-of-flight (TOF) cameras, a plurality of correlation samples, wherein the plurality of correlation samples includes a first set of correlation samples with a first integration time and a second set of correlation samples with a second integration time; determine that a first correlation sample from the first set of correlation samples is at least partly saturated; based on the determining that the first correlation sample is at least partly saturated, infer that a second correlation sample from the first set of correlation samples is also at least partly saturated; replace the first correlation sample and the second correlation sample with one or more scaled versions of one or more correlation samples from the second set of correlation samples; and generate a high dynamic range (HDR) TOF frame based at least on a combination of the one or more scaled versions of the one or more correlation samples from the second set of correlation samples and the second set of correlation samples.
Aspect 2. The system of Aspect 1, wherein inferring that the second correlation sample from the first set of correlation samples is also at least partly saturated is based on an inverse relationship between the first correlation sample and the second correlation sample.
Aspect 3. The system of Aspect 1 or 2, wherein the first correlation sample and the second correlation sample comprise a pair of in phase and out-of-phase correlation samples, and wherein inferring that the second correlation sample from the first set of correlation samples is also at least partly saturated is based on an in phase and out-of-phase relationship of the pair of in phase and out-of-phase correlation samples.
Aspect 4. The system of any of Aspects 1 to 3, wherein the one or more processors are configured to: scale the one or more correlation samples from the second set of correlation samples to yield the one or more scaled versions of the one or more correlation samples, wherein the one or more correlation samples are scaled based on the first integration time and the second integration time.
Aspect 5. The system of Aspect 4, wherein scaling the one or more correlation samples comprises dividing a first value of the first integration time by a second value of the second integration time.
Aspect 6. The system of any of Aspects 1 to 5, wherein the one or more processors are configured to: prior to generating the HDR TOF frame, determine a first pair of correlation samples and a second pair of correlation samples, wherein the first pair of correlation samples comprises the one or more scaled versions of the one or more correlation samples and a corresponding correlation sample from the second set of correlation samples, and wherein the second pair of correlation samples comprises an additional correlation sample and an additional corresponding correlation sample from the second set of correlation samples; apply a respective weight to each of the correlation samples in the first pair of correlation samples and the second pair of correlation samples; mix the weighted correlation samples in the first pair of correlation samples to yield a first enhanced correlation sample; and mix the weighted correlation samples in the second pair of correlation samples to yield a second enhanced correlation sample.
Aspect 7. The system of Aspect 6, wherein generating the HDR TOF frame comprises mixing the first enhanced correlation sample and the second enhanced correlation sample.
Aspect 8. The system of any of Aspects 6 or 7, wherein the respective weight associated with a particular correlation sample having the first integration time is determined by dividing a noise variance of the particular correlation sample by a result of adding the noise variance of the particular correlation sample with an additional noise variance of an addition correlation sample having the second integration time.
Aspect 9. The system of any of Aspects 6 to 8, wherein the respective weight associated with a particular correlation sample having the second integration time is determined by dividing a noise variance of the particular correlation sample by a result of adding the noise variance of the particular correlation sample with an additional noise variance of an addition correlation sample having the first integration time.
Aspect 10. The system of any of Aspects 1 to 9, wherein the one or more processors are configured to: determine, for each correlation sample from the second set of correlation samples, whether the correlation sample is at least partially saturated; and generate a confidence map based on the determining whether the correlation sample is at least partially saturated, wherein the confidence map comprises a representation of mask values associated with pixels of the correlation sample.
Aspect 11. A method comprising: obtaining, from one or more time-of-flight (TOF) cameras, a plurality of correlation samples, wherein the plurality of correlation samples includes a first set of correlation samples with a first integration time and a second set of correlation samples with a second integration time; determining that a first correlation sample from the first set of correlation samples is at least partly saturated; based on the determining that the first correlation sample is at least partly saturated, inferring that a second correlation sample from the first set of correlation samples is also at least partly saturated; replacing the first correlation sample and the second correlation sample with one or more scaled versions of one or more correlation samples from the second set of correlation samples; and generating a high dynamic range (HDR) TOF frame based at least on a combination of the one or more scaled versions of the one or more correlation samples from the second set of correlation samples and the second set of correlation samples.
Aspect 12. The method of Aspect 11, wherein inferring that the second correlation sample from the first set of correlation samples is also at least partly saturated is based on an inverse relationship between the first correlation sample and the second correlation sample.
Aspect 13. The method of Aspect 11 or 12, wherein the first correlation sample and the second correlation sample comprise a pair of in phase and out-of-phase correlation samples, and wherein inferring that the second correlation sample from the first set of correlation samples is also at least partly saturated is based on an in phase and out-of-phase relationship of the pair of in phase and out-of-phase correlation samples.
Aspect 14. The method of any of Aspects 11 to 13, further comprising: scaling the one or more correlation samples from the second set of correlation samples to yield the one or more scaled versions of the one or more correlation samples, wherein the one or more correlation samples are scaled based on the first integration time and the second integration time.
Aspect 15. The method of Aspect 14, wherein scaling the one or more correlation samples comprises dividing a first value of the first integration time by a second value of the second integration time.
Aspect 16. The method of any of Aspects 11 to 15, further comprising: prior to generating the HDR TOF frame, determining a first pair of correlation samples and a second pair of correlation samples, wherein the first pair of correlation samples comprises the one or more scaled versions of the one or more correlation samples and a corresponding correlation sample from the second set of correlation samples, and wherein the second pair of correlation samples comprises an additional correlation sample and an additional corresponding correlation sample from the second set of correlation samples; applying a respective weight to each of the correlation samples in the first pair of correlation samples and the second pair of correlation samples; mixing the weighted correlation samples in the first pair of correlation samples to yield a first enhanced correlation sample; and mixing the weighted correlation samples in the second pair of correlation samples to yield a second enhanced correlation sample.
Aspect 17. The method of Aspect 16, wherein generating the HDR TOF frame comprises mixing the first enhanced correlation sample and the second enhanced correlation sample.
Aspect 18. The method of Aspect 16 or 17, wherein the respective weight associated with a particular correlation sample having one of the first integration time or the second integration time is determined by dividing a noise variance of the particular correlation sample by a result of adding the noise variance of the particular correlation sample with an additional noise variance of an addition correlation sample having a different one of the first integration time or the second integration time.
Aspect 19. The method of any of Aspects 11 to 18, further comprising: determining, for each correlation sample from the second set of correlation samples, whether the correlation sample is at least partially saturated; and generating a confidence map based on the determining whether the correlation sample is at least partially saturated, wherein the confidence map comprises a representation of mask values associated with pixels of the correlation sample.
Aspect 20. The method of any of Aspects 11 to 19, wherein the one or more TOF cameras are implemented by an autonomous vehicle.
Aspect 21. The method of Aspect 20, further comprising: generating, by a computer of the autonomous vehicle based on the HDR TOF frame, depth information associated with a scene, the depth information comprising depth values indicating a respective depth of one or more portions of the scene relative to a location of the one or more TOF cameras within the scene.
Aspect 22. The method of any of Aspects 11 to 21, further comprising tracking, based on one or more HDR TOF frames, a depth of one or more locations in a scene associated with the one or more TOF cameras, wherein the one or more HDR TOF frames comprise the HDR TOF frame.
Aspect 23. The method of Aspect 22, wherein the depth of the one or more locations in the scene is relative to a position of the one or more TOF cameras within the scene.
Aspect 24. A non-transitory computer-readable medium having stored thereon instructions which, when executed by one or more processors, cause the one or more processors to perform a method according to any of Aspects 11 to 23.
Aspect 25. A system comprising means for performing a method according to any of Aspects 11 to 23.
Aspect 26. The system of Aspect 25, wherein the system comprises an autonomous vehicle and wherein the one or more TOF cameras are coupled to the autonomous vehicle.
Aspect 27. An autonomous vehicle comprising memory and one or more processors coupled to the memory, the one or more processors being configured to perform a method according to any of Aspects 11 to 23.
Aspect 28. A computer program product comprising instructions stored thereon which, when executed by one or more processors, cause the one or more processors to perform a method according to any of Aspects 11 to 23.

What is claimed is:

1. A system comprising:
a memory; and
one or more processors coupled to the memory, the one or more processors being configured to:
obtain, from one or more time-of-flight (TOF) cameras, a plurality of correlation samples, wherein the plurality of correlation samples includes a first set of correlation samples with a first integration time and a second set of correlation samples with a second integration time;
determine that a first correlation sample from the first set of correlation samples is at least partly saturated;
based on the determining that the first correlation sample is at least partly saturated, infer that a second correlation sample from the first set of correlation samples is also at least partly saturated;
replace the first correlation sample and the second correlation sample with one or more scaled versions of one or more correlation samples from the second set of correlation samples; and
generate a high dynamic range (HDR) TOF frame based at least on a combination of the one or more scaled versions of the one or more correlation samples from the second set of correlation samples and the second set of correlation samples.

2. The system of claim 1, wherein inferring that the second correlation sample from the first set of correlation samples is also at least partly saturated is based on an inverse relationship between the first correlation sample and the second correlation sample.

3. The system of claim 1, wherein the first correlation sample and the second correlation sample comprise a pair of in-phase and out-of-phase correlation samples, and wherein inferring that the second correlation sample from the first set of correlation samples is also at least partly saturated is based on an in phase and out-of-phase relationship of the pair of in phase and out-of-phase correlation samples.

4. The system of claim 1, wherein the one or more processors are configured to:
scale the one or more correlation samples from the second set of correlation samples to yield the one or more scaled versions of the one or more correlation samples, wherein the one or more correlation samples are scaled based on the first integration time and the second integration time.

5. The system of claim 4, wherein scaling the one or more correlation samples comprises dividing a first value of the first integration time by a second value of the second integration time.

6. The system of claim 1, wherein the one or more processors are configured to:
prior to generating the HDR TOF frame, determine a first pair of correlation samples and a second pair of correlation samples, wherein the first pair of correlation samples comprises the one or more scaled versions of the one or more correlation samples and a corresponding correlation sample from the second set of correlation samples, and wherein the second pair of correlation samples comprises an additional correlation sample and an additional corresponding correlation sample from the second set of correlation samples;
apply a respective weight to each of the correlation samples in the first pair of correlation samples and the second pair of correlation samples;
mix the weighted correlation samples in the first pair of correlation samples to yield a first enhanced correlation sample; and
mix the weighted correlation samples in the second pair of correlation samples to yield a second enhanced correlation sample.

7. The system of claim 6, wherein generating the HDR TOF frame comprises mixing the first enhanced correlation sample and the second enhanced correlation sample.

8. The system of claim 6, wherein the respective weight associated with a particular correlation sample having the first integration time is determined by dividing a noise variance of the particular correlation sample by a result of adding the noise variance of the particular correlation sample with an additional noise variance of an addition correlation sample having the second integration time.

9. The system of claim 6, wherein the respective weight associated with a particular correlation sample having the second integration time is determined by dividing a noise variance of the particular correlation sample by a result of adding the noise variance of the particular correlation sample with an additional noise variance of an addition correlation sample having the first integration time.

10. The system of claim 1, wherein the one or more processors are configured to:
determine, for each correlation sample from the second set of correlation samples, whether the correlation sample is at least partially saturated; and
generate a confidence map based on the determining whether the correlation sample is at least partially saturated, wherein the confidence map comprises a representation of mask values associated with pixels of the correlation sample.

11. A method comprising:
obtaining, from one or more time-of-flight (TOF) cameras, a plurality of correlation samples, wherein the plurality of correlation samples includes a first set of correlation samples with a first integration time and a second set of correlation samples with a second integration time;
determining that a first correlation sample from the first set of correlation samples is at least partly saturated;
based on the determining that the first correlation sample is at least partly saturated, inferring that a second correlation sample from the first set of correlation samples is also at least partly saturated;
replacing the first correlation sample and the second correlation sample with one or more scaled versions of one or more correlation samples from the second set of correlation samples; and
generating a high dynamic range (HDR) TOF frame based at least on a combination of the one or more scaled versions of the one or more correlation samples from the second set of correlation samples and the second set of correlation samples.

12. The method of claim 11, wherein inferring that the second correlation sample from the first set of correlation samples is also at least partly saturated is based on an inverse relationship between the first correlation sample and the second correlation sample.

13. The method of claim 11, wherein the first correlation sample and the second correlation sample comprise a pair of in phase and out-of-phase correlation samples, and wherein inferring that the second correlation sample from the first set of correlation samples is also at least partly saturated is based on an in phase and out-of-phase relationship of the pair of in phase and out-of-phase correlation samples.

14. The method of claim 11, further comprising:
scaling the one or more correlation samples from the second set of correlation samples to yield the one or more scaled versions of the one or more correlation samples, wherein the one or more correlation samples are scaled based on the first integration time and the second integration time.

15. The method of claim 14, wherein scaling the one or more correlation samples comprises dividing a first value of the first integration time by a second value of the second integration time.

16. The method of claim 11, further comprising:
prior to generating the HDR TOF frame, determining a first pair of correlation samples and a second pair of correlation samples, wherein the first pair of correlation samples comprises the one or more scaled versions of the one or more correlation samples and a corresponding correlation sample from the second set of correlation samples, and wherein the second pair of correlation samples comprises an additional correlation sample and an additional corresponding correlation sample from the second set of correlation samples;
applying a respective weight to each of the correlation samples in the first pair of correlation samples and the second pair of correlation samples;
mixing the weighted correlation samples in the first pair of correlation samples to yield a first enhanced correlation sample; and
mixing the weighted correlation samples in the second pair of correlation samples to yield a second enhanced correlation sample.

17. The method of claim 16, wherein generating the HDR TOF frame comprises mixing the first enhanced correlation sample and the second enhanced correlation sample.

18. The method of claim 16, wherein the respective weight associated with a particular correlation sample having one of the first integration time or the second integration time is determined by dividing a noise variance of the particular correlation sample by a result of adding the noise variance of the particular correlation sample with an additional noise variance of an addition correlation sample having a different one of the first integration time or the second integration time.

19. The method of claim 11, further comprising:
determining, for each correlation sample from the second set of correlation samples, whether the correlation sample is at least partially saturated; and
generating a confidence map based on the determining whether the correlation sample is at least partially saturated, wherein the confidence map comprises a representation of mask values associated with pixels of the correlation sample.

20. A non-transitory computer-readable medium having stored thereon instructions which, when executed by one or more processors, cause the one or more processors to:
obtain, from one or more time-of-flight (TOF) cameras, a plurality of correlation samples, wherein the plurality of correlation samples includes a first set of correlation samples with a first integration time and a second set of correlation samples with a second integration time;
determine that a first correlation sample from the first set of correlation samples is at least partly saturated;
based on the determining that the first correlation sample is at least partly saturated, infer that a second correlation sample from the first set of correlation samples is also at least partly saturated;
replace the first correlation sample and the second correlation sample with one or more scaled versions of one or more correlation samples from the second set of correlation samples; and
generate a high dynamic range (HDR) TOF frame based at least on a combination of the one or more scaled versions of the one or more correlation samples from the second set of correlation samples and the second set of correlation samples.
